(19) United States
(12) Patent Application Publication
(10) Pub. No.: US 2012/0141181 A1
(43) Pub. Date: Jun. 7, 2012

(54) SURFACE TREATING APPARATUS, IMAGE FORMING APPARATUS, AND IMAGE FORMING SYSTEM

(76) Inventors: Takashi BISAIJI, Kanagawa (JP); Hijiri Ogata, Miyagi (JP); Haruki Saitoh, Miyagi (JP)

(21) Appl. No.: 13/306,250

(22) Filed: Nov. 29, 2011

(30) Foreign Application Priority Data
Dec. 6, 2010 (JP) 2010-271885

(51) Int. Cl. G03G 15/00

(52) U.S. Cl. 399/390

(57) ABSTRACT

A surface treating apparatus configured to treat a surface of a transfer material includes a discharge part configured to cause dielectric barrier discharge on or near the surface of the transfer material where a toner image is to be formed on the surface and to cause the surface of the transfer material to be directly exposed to the dielectric barrier discharge, so as to increase the wettability of the surface of the transfer material with respect to toner for forming the toner image.

### BACKGROUND OF THE INVENTION

1. Field of the Invention

The present invention generally relates to a surface treating apparatus configured to treat a surface of a transfer material prior to transfer of a toner image onto the surface, an image forming apparatus, and an image forming system.

2. Description of the Related Art

Electrophotographic image forming apparatuses such as those using the Carlson process are known. Generally, in such an image forming apparatus, a photosensitive body having photoconductive characteristics is uniformly charged and then exposed to light in accordance with an image pattern, thereby producing a latent image as a charge distribution. The latent image is then developed by attaching positively or negatively charged colored fine resin particles (hereinafter referred to as “toner”). Thereafter, the toner on the photosensitive body is transferred onto a surface of a transfer material such as transfer paper using an electrostatic force. The transfer material is then passed between a pair of rollers under pressure so that the toner is fused onto the transfer material using the elasticity of the toner, thereby producing a final toner image. In general, fusing units that perform fusing the elasticity of toner employ thermal energy, while those using mechanical energy or chemical energy are also known.

According to toner fusing units using thermal energy, a toner image on a transfer material comes into direct contact with the surface of a fusing member such as a heated roller. As a result, a phenomenon called “offsetting,” where part of the toner image is attached to the surface of the fusing member, or a phenomenon called “wrapping,” where the transfer material is wrapped around the fusing member, may occur.

As a method for preventing such offsetting or wrapping, it is known to form a mold release layer of Teflon (registered trademark) or silicone on the surface of the fusing member and apply oil as a mold release agent (such as silicone oil) on the surface of the fusing member. (See, for example, “Electrophotography—Bases and Applications,” edited by the Society of Electrophotography of Japan, 1st edition, published by Corona Publishing Co., Ltd., Jun. 15, 1988, pp. 321-324.)

In another method, a monochrome image or a full-color image is formed using a toner to which a mold release agent such as wax is added (hereinafter referred to as “oil-less toner”), so that the amount of oil applied onto the surface of the fusing member may be reduced or even the application of oil may be omitted. (See, for example, Japanese Laid-Open Patent Application No. 62-100775, Japanese Laid-Open Patent Application No. 3-91764, Japanese Laid-Open Patent Application No. 3-168649, Japanese Laid-Open Patent Application No. 8-334919, and Japanese Laid-Open Patent Application No. 2006-39101.) For example, Japanese Laid-Open Patent Application No. 2006-39101 discusses a method of introducing a mold release agent such as wax into toner to prevent the occurrence of offsetting or wrapping.

In recent years, as image forming apparatuses using electrophotography have become higher in speed and image quality, various peripheral devices for paper processing have been made available. Further, image forming apparatuses using electrophotography make it possible to process electronic data by exposing a photosensitive body to light without preparing a printing plate. For these reasons, image forming apparatuses using electrophotography have started to be used as print-on-demand (“POD”) machines in applications where printing machines such as offset printing machines have been conventionally used.

Since the POD machines have started to be used in areas where printing machines such as offset printing machines have been conventionally used as described above, the number of kinds of transfer paper to be handled has greatly increased. For example, there is a demand for printing on coated paper, plastic paper using a resin material as a base, etc., which improve grade and surface appearance, in addition to non-coated high-quality or intermediate-quality paper used in office and called “plain paper.” Further, there is also a demand for dealing with transfer paper having a basis weight of 50 g/m² to 300 g/m² or more. Further, the electrophotographic POD machines use an electrostatic force in the process up to transfer of toner onto transfer paper. Therefore, the same quality as with common plain paper may be obtained with the above-described various kinds of transfer paper if it is possible to provide such an electric field as to enable transfer of toner onto the transfer paper.

According to the electrophotographic image forming apparatus, in a fusing process where toner is melted to be fixed onto transfer paper, it is possible to achieve the quality of the fusing by providing thermal energy that causes the toner to be sufficiently melted. However, in a current mainstream fusing system where fusing is performed between multiple (usually two) rollers in a fusing process, it may be difficult to cause toner to adhere sufficiently to transfer paper even with provision of heat (thermal energy) at an upper limit temperature determined by components or safety considerations, depending on the heat capacity of the transfer paper determined by its material and basis weight. This phenomenon, or difficulty in causing toner to adhere sufficiently to transfer paper, is conspicuous in the case of using the above-described oil-less toner. An actual post-fusing observation of a toner image formed using oil-less toner showed that the toner was melted into a film to allow no simple adhesion to the surface of the transfer paper. According to this observation result, it is believed that depending on the kind of transfer paper, the phenomenon becomes apparent that a mold release agent contained in the toner, such as wax, acts between the transfer paper and the toner as well to prevent the melted toner from being fused onto the surface of the transfer paper. Thus, in the case of using oil-less toner in electrophotographic POD machines, which have started to be used in applications where printing machines such as offset printing machines have been conventionally used, it is not possible to support all of the kinds of transfer paper covered by the conventional printing machines in terms of fusing quality in particular.

Japanese Patent No. 3665693 discusses a paper surface quality converter having an object of varying a toner fusing characteristic as desired and configured to increase or decrease the toner fusing characteristic of a paper surface by changing charge polarity with which the paper surface is charged by corona discharge. For example, the toner fusing characteristic of the paper surface is increased by positively charging the paper surface by corona discharge. Further, the toner fusing characteristic of paper surface is decreased by negatively charging the paper surface by corona discharge. However, according to the paper surface quality converter of Japanese Patent No. 3665693, only the charging of the paper surface by corona discharge and slight oxidation due to ozone generated by corona discharge contribute to an increase in wettability. This prevents the wettability of the paper surface from being sufficiently improved with respect to the oil-less toner containing a mold release agent. As a result, it is not possible to ensure a good fusing characteristic in the case of forming a toner image using oil-less toner. Further, in Japanese Patent No. 3665693, there is no disclosure of the relationship between the fusing characteristic in the case of forming a toner image using the above-described oil-less toner containing a mold release agent and the discharge used to convert the quality of paper surface before forming such a toner image using the oil-less toner.

### SUMMARY OF THE INVENTION

According to an aspect of the present invention, a surface treating apparatus configured to treat a surface of a transfer material includes a discharge part configured to cause a dielectric barrier discharge on or near the surface of the transfer material where a toner image is to be formed and to cause the surface of the transfer material to be directly exposed to the dielectric barrier discharge, so as to increase a wettability of the surface of the transfer material with respect to a toner for forming the toner image.

According to an aspect of the present invention, an image forming apparatus includes a toner image forming part configured to form a toner image on a surface of a transfer material; a fusing part configured to fuse the toner image using a fusing member; and a surface treating unit configured to treat the surface of the transfer material to be conveyed to the toner image forming part, the surface treating unit including a discharge part configured to cause a discharge on or near the surface of the transfer material where the toner image is to be formed.

According to an aspect of the present invention, an image forming system includes an image forming apparatus including a toner image forming part configured to form a toner image on a surface of a transfer material; and a fusing part configured to fuse the toner image using a fusing member; and a transfer material treating apparatus configured to treat the surface of the transfer material to be conveyed to the toner image forming part, the transfer material treating apparatus including a transfer material input part to which the transfer material is input; a surface treating unit configured to treat the surface of the transfer material fed from the transfer material input part on which surface the toner image is to be formed, the surface treating unit including a discharge part configured to cause a discharge on or near the surface of the transfer material where the toner image is to be formed; and a transfer material output part configured to output the transfer material that has the surface thereof treated in the surface treating unit.

### BRIEF DESCRIPTION OF THE DRAWINGS

Other objects, features and advantages of the present invention will become more apparent from the following detailed description when read in conjunction with the accompanying drawings, in which:

FIG. 1 is a schematic diagram illustrating a configuration of an image forming apparatus according to a first embodiment of the present invention;

FIG. 2 is a schematic diagram illustrating states of a toner image formed on transfer paper using a toner containing wax before and after fusing according to the first embodiment of the present invention;

FIG. 3 is a diagram illustrating additives such as wax added to the toner according to the first embodiment of the present invention;

FIG. 4 is a schematic diagram illustrating a configuration of a surface treating unit according to the first embodiment of the present invention;

FIG. 5 is a diagram illustrating another configuration of the surface treating unit according to the first embodiment of the present invention;

FIG. 6 is a diagram illustrating the size of and the positional relationship between a first electrode roller and a second electrode roller of the surface treating unit according to the first embodiment of the present invention;

FIG. 7 is a schematic diagram illustrating a laboratory apparatus used to confirm the effect of a discharge process in the image forming apparatus according to the first embodiment of the present invention;

FIG. 8 is a schematic diagram illustrating a configuration of the surface treating unit according to a second embodiment of the present invention;

FIG. 9 is a schematic diagram illustrating another configuration of the surface treating unit according to the second embodiment of the present invention;

FIG. 10 is a schematic diagram illustrating a configuration of an image forming system according to a third embodiment of the present invention;

FIG. 11 is a schematic diagram illustrating a configuration of a transfer material treating apparatus according to a fourth embodiment of the present invention; and

FIG. 12 is a schematic diagram illustrating a configuration of a transfer material treating apparatus according to a fifth embodiment of the present invention.

### DETAILED DESCRIPTION OF THE PREFERRED EMBODIMENTS

A description is given below, with reference to the accompanying drawings, of embodiments of the present invention.

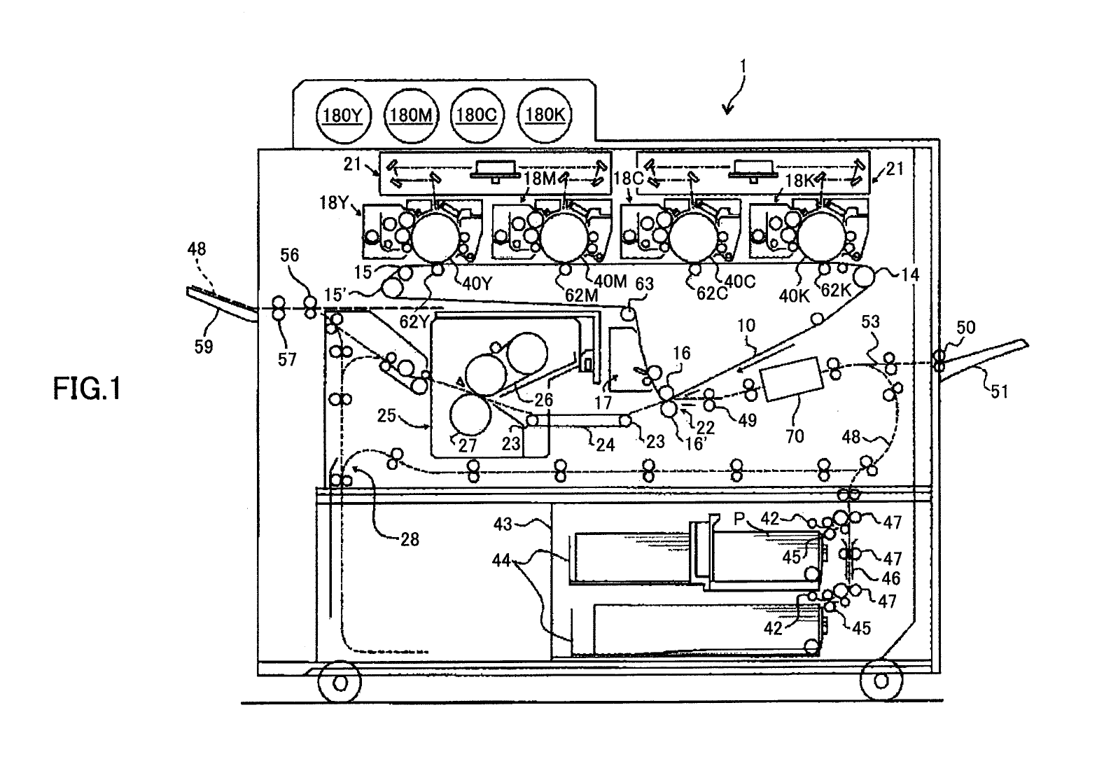

FIG. 1 is a schematic diagram illustrating an image forming apparatus 1 according to a first embodiment of the present invention. According to this embodiment, the image forming apparatus 1 is a full-color image forming apparatus capable of forming a full-color image using electrophotography. The image forming apparatus 1 may be used as a full-color POD machine.

The image forming apparatus 1 includes two optical writing units 21 and four process units 18Y, 18M, 18C, and 18K that operate as four toner image forming parts configured to form toner images of yellow (Y), magenta (M), cyan (C), and black (K), respectively. The image forming apparatus 1 also includes a paper feed part 43 having two paper feed cassettes 44. The image forming apparatus 1 further includes a registration roller pair 49, a conveyance switching unit (transfer paper re-feed unit) 28, a post-fusing paper ejecting roller pair 56, a conveyance roller pair 57 configured to convey a sheet of transfer paper P after fusing, and a paper output tray 59 serving as a transfer material output part, which are so provided as to form a transfer paper conveyance path 48, through which the transfer paper P as a transfer material fed from the paper feed part 43 is conveyed and output. The image forming apparatus 1 also includes a manual feed roller pair 50, a manual feed tray 51, and a manual paper feed path 53. Hereinafter, the sheet of transfer paper P may also be referred to as “transfer paper P” for simplification.

The image forming apparatus 1 further includes an intermediate transfer belt 10 serving as an intermediate transfer body; an intermediate transfer unit configured to transfer a toner image formed by the process units 18Y, 18M, 18C, and 18K onto the transfer paper P via the intermediate transfer belt 10; a fusing unit 25 serving as a fusing part configured to fuse the toner image onto the transfer paper P; a conveyor belt 24 wound around and extended between support rollers 23; and a conveyor belt unit configured to convey the transfer paper P onto which the toner image has been fused to the fusing unit 25 using the conveyor belt 24. The conveyance switching unit (transfer paper re-feed unit) 28 is configured to allow toner images to be formed one on each side of the transfer paper P. Further, as described in detail below, the image forming apparatus 1 further includes a surface treating unit (apparatus) 70 configured to treat a surface of the transfer paper P fed from the paper feed part 43 or the manual feed tray 51.

Each of the paper feed cassettes 44 is configured to store a stack of sheets of transfer paper P. The transfer paper P at the top of the paper stack in either paper feed cassette 44 is fed out by the rotation of a corresponding paper feed roller 42. The transfer paper P fed out from the paper feed cassette 44 is conveyed toward the transfer paper conveyance path 48 through a paper feed path 46 by paper feed rollers 45 and 47. The manual feed tray 51 is so mounted on one side of a housing of the image forming apparatus 1 as to be openable and closable with respect to the housing. A stack of sheets of transfer paper P may be manually placed on the upper surface of the manual feed tray 51 with the manual feed tray 51 being open with respect to the housing. The transfer paper P at the top of the manually-placed paper stack is fed out to the transfer paper conveyance path 48 by the manual feed roller pair 50.

Each of the optical writing units 21 includes a light source such as a semiconductor laser (laser diode [LD]), a polygon mirror, and various lenses. The optical writing units 21 drive their respective light sources based on image information read by an external image reader (scanner) or image information sent from an external apparatus such as a computer unit to optically scan photosensitive bodies 40Y, 40M, 40C, and 40K of the process units 18Y, 18M, 180, and 18K with laser light. For example, the photosensitive bodies 40Y, 40M, 40C, and 40K of the process units 18Y, 18M, 18C, and 18K are rotated counterclockwise in FIG. 1 by respective drive parts (not graphically illustrated). The optical writing unit 21 on the left side in FIG. 1 is configured to optically scan the rotating photosensitive bodies 40Y and 40M by emitting laser light onto each of the photosensitive bodies 40Y and 40M while deflecting the laser light in a direction of its axis of rotation. As a result, electrostatic latent images based on Y image information and M image information are formed on the photosensitive bodies 40Y and 40M, respectively. Likewise, the optical writing unit 21 on the right side in FIG. 1 is configured to optically scan the rotating photosensitive bodies 40C and 40K by emitting laser light onto each of the photosensitive bodies 40C and 40K while deflecting the laser light in a direction of its axis of rotation. As a result, electrostatic latent images based on C image information and K image information are formed on the photosensitive bodies 40C and 40K, respectively.

The process units 18Y, 18M, 18C, and 18K include their respective drum-shaped photosensitive bodies 40Y, 40M, 40C, and 40K serving as latent image carriers. Further, each of the process units 18Y, 18M, 18C, and 18K supports the corresponding photosensitive body (40Y, 40M, 40C or 40K) and various devices provided around the photosensitive body on a common support body as a single unit. The process units 18Y, 18M, 180, and 18K are detachable from and reattachable to the body (housing) of the image forming apparatus 1. The process units 18Y, 18M, 18C, and 18K have the same configuration except that the colors of the toners used are different from one another. The image forming apparatus 1 of this embodiment has a so-called tandem configuration where these process units 18Y, 18M, 18C, and 18K are arranged along the endless moving direction of the intermediate transfer belt 10 to face the extension part of the intermediate transfer belt 10 between support rollers such as rollers 14 and 15.

A description is given of a configuration of the process unit according to this embodiment, taking the process unit 18Y, which is configured to form a yellow (Y) toner image, as an example.

In addition to the photosensitive body 40Y, the process unit 18Y includes a developing unit configured to develop an electrostatic latent image formed on the surface of the photosensitive body 40Y into a Y toner image. Further, the process unit 18Y includes a charging unit configured to uniformly charge the surface of the photosensitive body 40Y as the photosensitive body 40Y rotates; and a drum cleaner configured to remove residual toner from the surface of the photosensitive body 40Y after its passing through a primary transfer nip for yellow color. The charging unit, the developing unit, and the drum cleaner are arranged in this order along the rotation direction of the photosensitive body 40Y.

A drum-shaped body having a photosensitive layer formed on an element tube of aluminum or the like by applying an organic photosensitive material having photosensitivity is employed as the photosensitive body 40Y. Alternatively, an endless belt-shaped body may be used as the photosensitive body 40Y.

The developing unit for yellow color is configured to develop a latent image using a two-component developer (not graphically illustrated) containing a magnetic carrier and non-magnetic Y toner. Alternatively, a developing unit may be used that is configured to perform development using a single-component developer, which contains no magnetic carrier, in place of the two-component developer. The two-component developer or the single-component developer may be hereinafter referred to simply as “developer.” The developing unit is suitably supplied with Y toner in a Y toner bottle 180 by a Y toner supplying unit (not graphically illustrated). A description is given below of toner that may be used in the developing unit of each of the process units 18Y, 18M, 18C, and 18K.

A drum cleaner configured to press a polyurethane rubber cleaning blade, which is a cleaning member, against the photosensitive body 40Y is used as the drum cleaner of the process unit 18Y. A drum cleaner of a different system may also be used. Further, in the image forming apparatus 1, the drum cleaner is configured to bring a rotatable fur brush into contact with the photosensitive body 40Y in order to improve the cleaning characteristic. The fur brush also serves to scrape a solid lubricant (not graphically illustrated) and apply fine powder of the scraped lubricant on the surface of the photosensitive body 40Y.

A discharge lamp (not graphically illustrated) is provided above the photosensitive body 40Y. This discharge lamp also is part of the process unit 40Y. The discharge lamp is configured to discharge the surface of the photosensitive body 40Y that has passed the drum cleaner by exposing the surface to light. The discharged surface of the photosensitive body 40Y is subjected to the above-described optical scanning by the optical writing unit 21 for Y color and M color after being uniformly charged by the charging unit. The charging unit rotates while being supplied with a charging bias from a power supply (not graphically illustrated). Alternatively, a scorotron charging system may be employed that charges the photosensitive body 40Y in a contactless manner.

A description is given above of the process unit 18Y. The process units 18M, 18C, and 18K have the same configuration as the process unit 18Y. For example, the developing units of the process units 18M, 18C, and 18K are supplied with toners of corresponding colors from toner bottles 180M, 180C, or 180K by a M toner supplying unit, a C toner supplying unit, and a K toner supplying unit (not graphically illustrated), respectively.

The intermediate transfer unit is disposed under the four process units 18Y, 18M, 18C, and 18K. The intermediate transfer unit includes the intermediate transfer belt 10 wound around and extended over the rollers 14 and 15 and rollers 15′, 16, and 63. The intermediate transfer belt 10 is caused to move clockwise in FIG. 1 in an endless manner by the rotation of one of the rollers 14, 15, 15′, 16, and 63 while being in contact with the photosensitive bodies 40Y, 40M, 40C, and 40K. As a result, the primary transfer nips for Y color, M color, C color, and K color are formed where the photosensitive bodies 40Y, 40M, 40C, and 40K come into contact with the intermediate transfer belt 10.

Near the primary transfer nips for Y color, M color, C color, and K color, the intermediate transfer belt 10 is pressed against the photosensitive bodies 40Y, 40M, 40C, and 40K by primary transfer rollers 62Y, 62M, 62C, and 62K (serving as primary transfer members) disposed inside the loop of the intermediate transfer belt 10. The primary transfer rollers 62Y, 62M, 62C, and 62K are supplied with a primary transfer bias from a power supply (not graphically illustrated). As a result, primary transfer electric fields that electrostatically transfer toner images on the photosensitive bodies 40Y, 40M, 40C, and 40K onto the intermediate transfer belt 10 are formed in the primary transfer nips for Y color, M color, C color, and K color.

As the intermediate transfer belt 10 moves endlessly in the clockwise direction in FIG. 1, on the top (outside) surface of the intermediate transfer belt 10 that passes the primary transfer nips for Y color, M color, C color, and K color one after another, the toner image are successively superposed in the respective primary transfer nips (a primary transfer of toner images). As a result of this primary transfer of superposition, a (composite) toner image of four superposed colors (hereinafter referred to as “four-color toner image”) is formed on the top (outer) surface of the intermediate transfer belt 10.

In a secondary transfer part 22 under the intermediate transfer belt 10 in FIG. 1, a secondary transfer roller 16′ serving as a secondary transfer member is provided. The secondary transfer roller 16′ forms a secondary transfer nip by contacting part of the intermediate transfer belt 10 wound around the roller (secondary transfer backup roller) 16 on the outer surface side of the intermediate transfer belt 10. As a result, the secondary transfer nip is formed where the outer surface of the intermediate transfer belt 10 comes into contact with the secondary transfer roller 16′.

A secondary transfer bias is applied to the secondary transfer roller 16′ by a power supply (not graphically illustrated). On the other hand, the secondary transfer backup roller 16 inside the belt loop is grounded. Thus, a secondary transfer electric field is formed in the secondary transfer nip.

To the right of the secondary transfer part 22 in FIG. 1, the registration roller pair 49 is disposed. The registration roller pair 49 is configured to send the transfer paper P held between the pair of rollers 49 into the secondary transfer nip with such timing as to allow the transfer paper P to synchronize with the four-color toner image on the intermediate transfer belt 10. In the secondary transfer nip, the four-color toner image on the intermediate transfer belt 10 is transferred onto the transfer paper P at a time in a secondary transfer process by the effect of the secondary transfer electric field and a nip pressure. As a result, a full-color image is formed with the white color of the transfer paper P.

On the outer surface of the intermediate transfer belt 10 that has passed through the secondary transfer nip, residual toner that has not been transferred onto the transfer paper P in the secondary transfer nip is attached. The residual toner is removed by a belt cleaner 17 in contact with the intermediate transfer belt 10.

The transfer paper P that has passed through the secondary transfer nip is then separated from the intermediate transfer belt 10 and delivered to the above-described conveyor belt unit. While having the endless conveyor belt 24 extended (stretched) between the two rollers 23 (a driving roller and a driven roller), the conveyor belt unit causes the conveyor belt 24 to move endlessly in the counterclockwise direction in FIG. 1 with the rotation of the driving roller 23. Then, while keeping the transfer paper P transferred from the secondary transfer nip on the stretched surface of the conveyor belt 24, the conveyor belt unit conveys the transfer paper P with the endless movement of the conveyor belt 24 and transfers the transfer paper P to the fusing unit 25.

Referring to FIG. 1, the transfer paper P fed from the paper feed unit 43 or the manual feed tray 51 is sent out to the surface treating unit 70. The transfer paper P is subjected to surface treatment in the surface treating unit 70 and then conveyed by the registration rollers 49 to the secondary transfer part 22.

Next, a description is given of surface treatment of the transfer paper P using the surface treating unit 70 of the image forming apparatus 1.

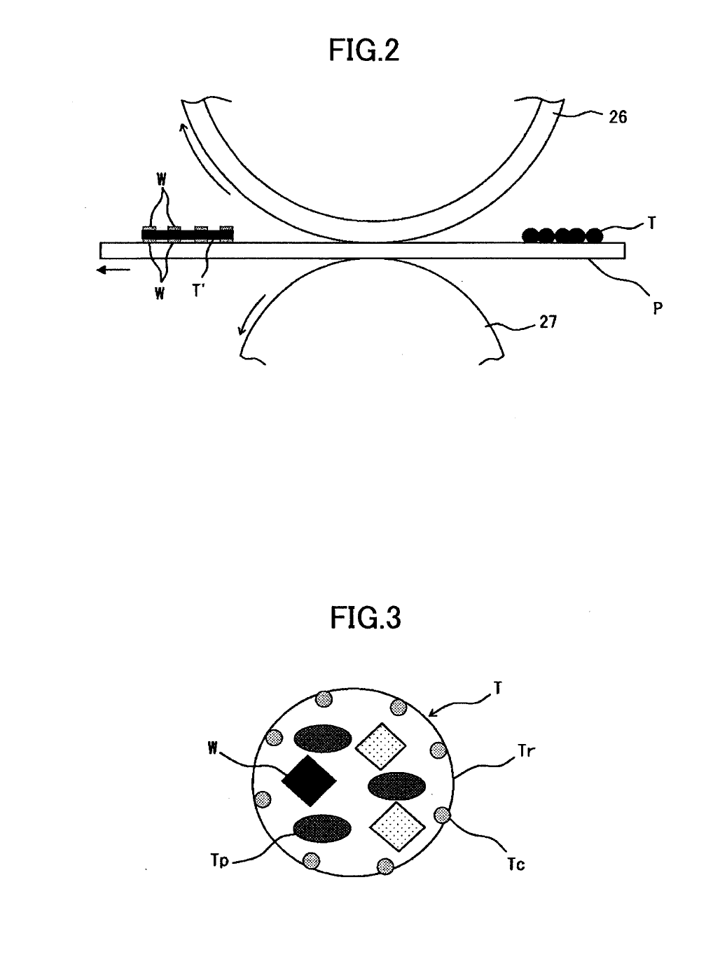

FIG. 2 is a schematic diagram illustrating states of the surface of the transfer paper P before and after a fusing process in which a toner image is fused that has been formed on the transfer paper P using toner containing a mold release agent such as wax using a fusing member (including a fusing belt 26 and a fusing roller 27). FIG. 3 is a diagram illustrating additives such as wax added to the toner. As described below, a toner T may contain a resin Tr as a principal component and a pigment Tp and a charge control agent Tc as additives. A wax or the like as a mold release agent may be further added. In the case of fusing a toner image formed on the transfer paper P using the toner T including the wax W, the toner T on the transfer paper P before fusing is in the form of powder and fixed on the transfer paper P by an electrostatic force. Then, the toner T on the transfer paper P is melted to be fixed (fused) onto the transfer paper P by a fusing process. At the time of fusing, the wax W contained in the toner T seeps out onto the top side of a toner image T′ and produces the effect of facilitating the release of the toner image T′ from the fusing member (the fusing belt 26). At the same time, the wax W also seeps out onto the bottom side of the toner image T′ on the transfer paper P after fusing, and remains on the bottom side to act on the adhesion between the transfer paper P and the toner image T′.

The wax, which is used for producing the effect of improving the releasing characteristic, is a material extremely low in wettability. Thus, the wax is believed to act to reduce adhesion to the transfer paper P.

Therefore, according to this embodiment, the image forming apparatus 1 includes a surface treating unit 70 configured to treat the surface of the transfer paper P fed from the paper feed part 43 or the manual feed tray 51 so as to improve the wettability of the surface of the transfer paper P with respect to the release agent such as wax. The surface treating unit 70 includes a discharge part configured to cause dielectric-barrier discharge on or near the surface of the transfer paper P so that the surface of the transfer paper P is directly exposed to the dielectric barrier discharge. This surface treatment by direct exposure to dielectric barrier discharge makes it possible to dramatically (by one or more orders of magnitude, for example) increase the amount of energy provided to the surface of the transfer paper P and to generate a wider variety of active species in a region in contact with the surface of the transfer paper P compared with the conventional case of using corona discharge. Thus, even in the case of forming a toner image on the transfer paper P using oil-less toner containing a release agent, it is possible to ensure an increase in the wettability of the surface of the transfer paper P with respect to the oil-less toner of the toner image. In addition, the above-described discharge makes it possible to increase the wettability of the surface of the transfer paper P with respect to the oil-less toner of the toner image regardless of the charge polarity due to discharge.

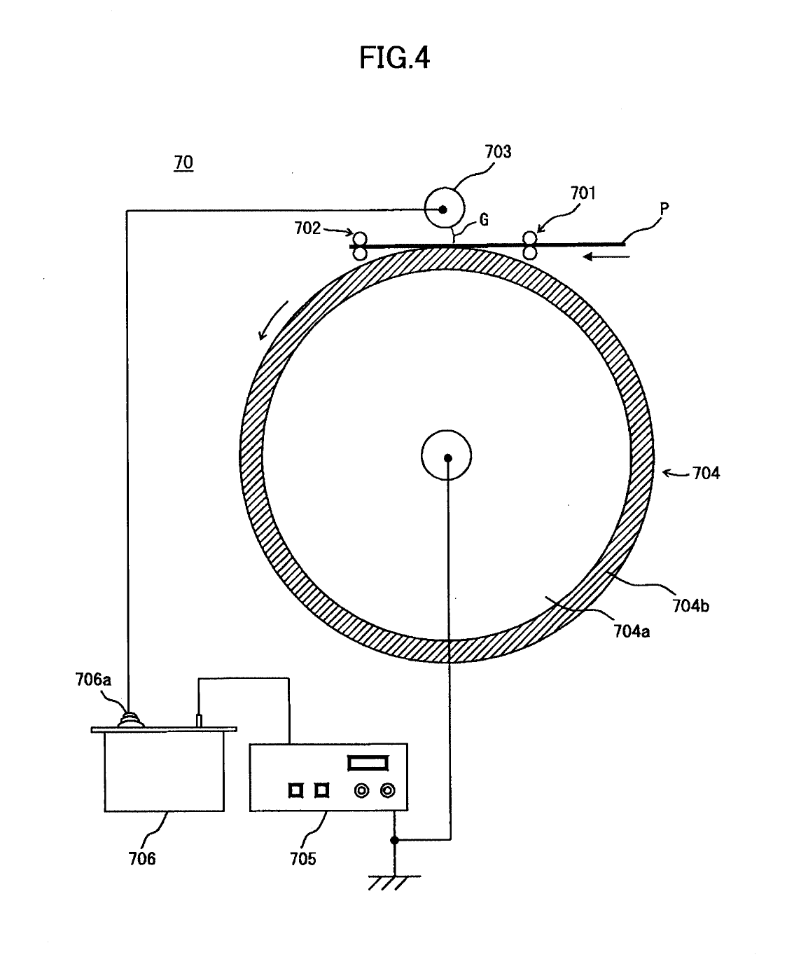

FIG. 4 is a schematic diagram illustrating a configuration of the surface treating unit 70 according to this embodiment. The surface treating unit 70 includes a discharge process part as the above-described discharge part; and pairs of conveyance rollers 701 and 702 as a conveyance part configured to convey the transfer paper P fed from the paper feed part 43 or the manual feed tray 51, so that the transfer paper P passes through a discharge occurrence region where discharge is caused. The discharge process part includes a first electrode roller 703 serving as an electrically conductive first electrode member; a second electrode roller 704 serving as a second electrode member and provided opposite the first electrode roller 703; and a voltage applying part configured to apply a predetermined voltage between the first electrode roller 703 and the second electrode roller 704. The first electrode roller 703 is opposed across a gap G to the surface of the transfer paper P conveyed by the conveyance roller pairs 701 and 702 to extend in a direction to cross the moving direction of the transfer paper P (in which the transfer paper P is moved or conveyed) indicated by arrow in FIG. 4.

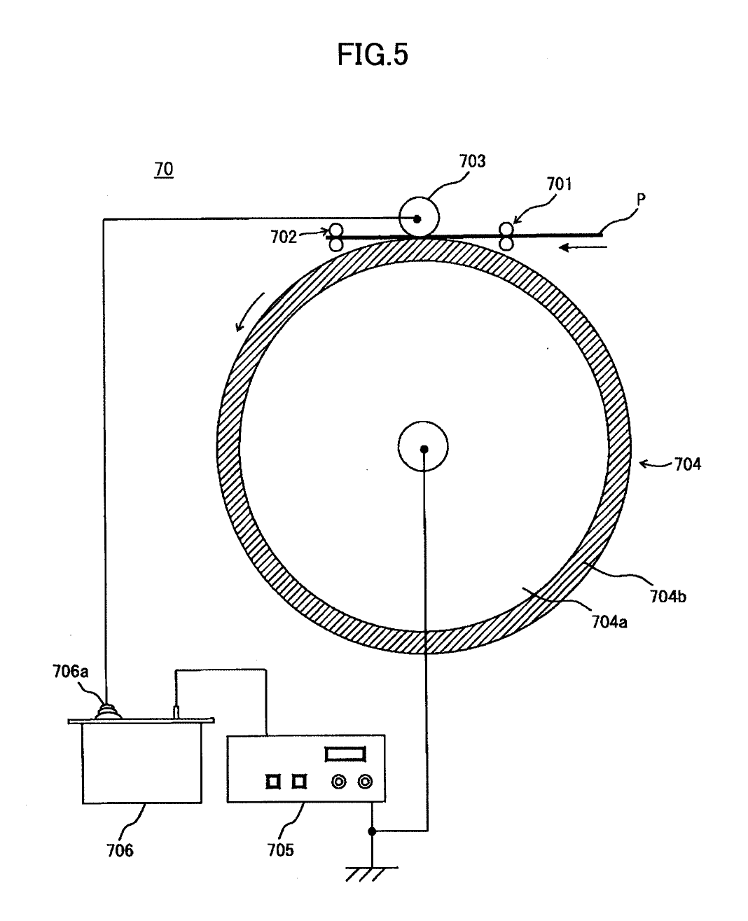

Here, as illustrated in FIG. 5, the first electrode roller 703 may be so provided as to come into contact with the surface of the transfer paper P. It is suitable to provide the gap G if, for example, the transfer paper P is formed of such a soft material that the surface of the transfer paper P is susceptible to damage. On the other hand, the contact between the first electrode roller 703 and the surface of the transfer paper P makes it possible to reduce the energy provided to the first electrode roller 703. For example, the presence or absence of the gap G may be selected, that is, it may be determined whether the first electrode roller 703 comes into contact with or is provided across the gap G from the surface of the transfer paper P, in accordance with the type of the transfer paper P and/or use conditions.

The second electrode roller 704 includes a roller-shaped core metal portion 704a formed of an electrically conductive member and a dielectric layer 704b formed on the surface of the core metal portion 704a. Referring to FIG. 4 and FIG. 5, the second electrode roller 704 is provided opposite the first electrode roller 703 with the transfer paper P interposed between the first electrode roller 703 and the second electrode roller 704.

The voltage applying part includes a high frequency generator 705 configured to generate an alternating-current (AC) voltage of a predetermined frequency f; and a high-voltage transformer 706 configured to raise the AC voltage output from the high frequency generator 705 to a predetermined voltage. As the high frequency generator 705, a high frequency power supply (CT-0212) manufactured by Kasuga Electric Works Ltd., may be used. As the high-voltage transformer 706, a transformer (CT-T02W) manufactured by Kasuga Electric Works Ltd., may be used. In the examples of FIG. 4 and FIG. 5, the core metal portion 704a of the second electrode roller 704 and the ground terminal of the high-frequency generator 705 are grounded. An output terminal 706a of the high-voltage transformer 706 is connected to the first electrode roller 703. The high-voltage transformer 706 outputs an AC voltage of the predetermined frequency and voltage value from the output terminal 706a. In response to application of the predetermined AC voltage to the first electrode roller 703, a dielectric barrier discharge is caused between the first electrode roller 703 and the surface of the transfer paper P that is being conveyed in contact with the second electrode roller 704.

In the surface treating unit 70 having the above-described configuration, the frequency f of the output AC voltage of the high frequency generator 705 is preferably higher than or equal to 20 kHz and lower than or equal to 500 kHz. A frequency range lower than and up to 20 Hz, which overlaps the human audible range and causes unpleasant and dissonant noise to be generated during discharge, is not preferable. Further, a frequency range lower than 20 Hz and down to direct current, in which discharge is not caused uniformly in the axial directions of the first electrode roller 703 and the second electrode roller 704 (discharge concentrates locally), is not preferable. On the other hand, in a frequency range higher than 500 kHz, a low-resistance discharge channel due to residual ions, which are ions generated by discharge and remaining in the gap G, is likely to be formed. Therefore, not only does discharge concentrate locally to prevent uniform treatment, but also a large current flows to generate high temperatures, which is not preferable from a safety point of view as well. In this case, the waveform of the output AC voltage of the high frequency generator 705 is not limited in particular as long as the frequency is within the above-described range of 20 kHz through 500 kHz, and may be a sine wave or a square wave (including a pulse waveform).

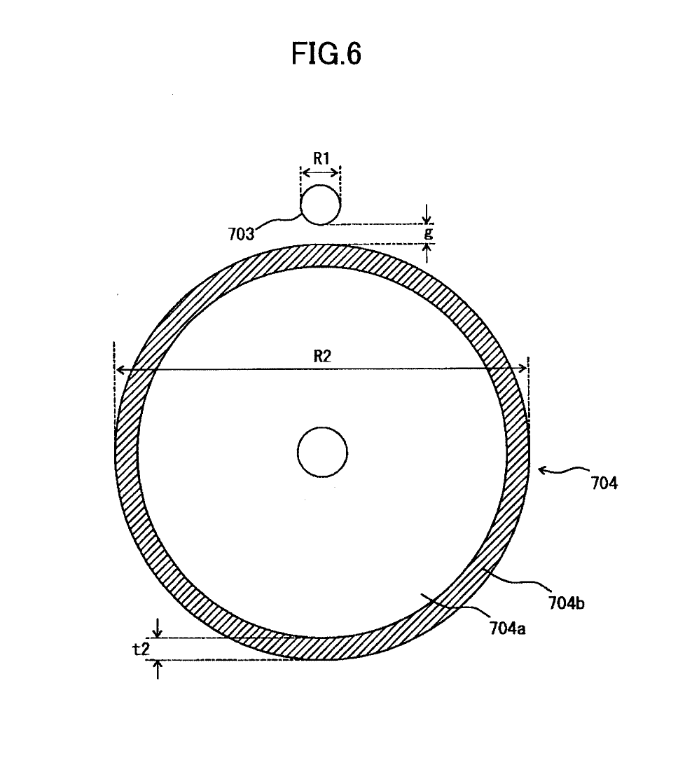

The output voltage value (peak-to-peak voltage) of the high-voltage transformer 706 applied to the first electrode roller 703 may be suitably determined based on the dielectric characteristics and/or thickness of the transfer paper P and the dielectric layer 704b of the second electrode roller 704 and the size of a gap g (FIG. 6) between the first electrode roller 703 and the second electrode roller 704. The output voltage value is preferably higher than or equal to 5 kVp-p and lower than or equal to 30 kVp-p when the gap g is 1 mm. If the output voltage value of the high-voltage transformer 706 is lower than 5 kVp-p, the breakdown voltage of the air existing in the gap g may not be reached and discharge may not be caused, which is not preferable. If the output voltage value of the high-voltage transformer 706 is higher than 30 kVp-p, it is highly likely that arc discharge is caused between the first electrode roller 703 and its surrounding members, which is not preferable for safety reasons. The gap g between the first electrode roller 703 and the second electrode roller 704 is substantially proportional to the preferable range of the output voltage value of the high-voltage transformer 706. Thus, when the gap g is other than 1 mm, the output voltage value of the high-voltage transformer 706 for the gap g may be determined based on the preferable range of 5 kVp-p to 30 kVp-p for the gap g of 1 mm.

The size of the gap g between the first electrode roller 703 and the second electrode roller 704 may be greater than or equal to the thickness of the transfer paper P to be processed (treated), and is preferably about 3 mm or less. When the gap g is 3 mm or more, a high voltage may be required for discharge, which is not preferable.

The material of the first electrode roller 703 may be suitably selected from metals such as iron, copper, aluminum, and stainless steel. Of these, stainless steel, which is less likely to be corroded by ozone generated during discharge, is preferable. The same applies to the core material of the second electrode roller 704 as to the material of the first electrode roller 703.

Referring to FIG. 6, a diameter R2 of the second electrode roller 704 is preferably greater than a diameter R1 of the first electrode roller 703. That is, it is more preferable that the second electrode roller 704 be considered to be a plane when viewed from the side of the first electrode roller 703. As a result of the second electrode roller 704 being considered to be a plane in a view from the side of the first electrode roller 703, it is possible to provide the surface of the transfer paper P with a wider and more uniform discharge region (a region of so-called creeping discharge caused in the moving direction of the transfer paper P) at a position where the first electrode roller 703 and the second electrode roller 704 are opposite to each other, so that a uniform and efficient treatment effect is produced. On the other hand, if the diameter R2 of the second electrode roller 704 is smaller than the diameter R1 of the first electrode roller 703, the discharge region concentrates on the region of the minimum distance between the first electrode roller 703 and the second electrode roller 704, so that the distance of creeping discharge is reduced. As a result, the treatment is performed in an extremely narrow (linear) region. Accordingly, even the slightest variation in the conveyance speed of the transfer paper P causes irregularities in the treatment in the plane of the transfer paper P, and the degradation of the dielectric layer 704b and the like is accelerated because of the concentrated discharge power.

The material of the dielectric layer 704b of the second electrode roller 704 may be suitably selected from plastics such as acrylic, polyester, polyethylene, polytetrafluoroethylene, and polyimide; rubber such as silicone rubber; and ceramics such as glass, quartz, alumina, zirconia, and titania. Glass, quartz, alumina, etc., which are less likely to be corroded by discharge and have a relative permittivity of 2 or more and 10 or less, are preferable. If the relative permittivity is less than 2, a high voltage may be required for discharge, which is not preferable. If the relative permittivity is more than 10, discharge is likely to concentrate locally, which is not preferable.

Referring to FIG. 6, a thickness t2 of the dielectric layer 704b is preferably more than or equal to 0.1 mm and less than or equal to 5 mm. If the thickness t2 is less than 0.1 mm, arc discharge is caused by breakdown, which is not preferable for safety reasons. In the case of glass, quartz, alumina, etc., the thickness t2 of the dielectric layer 704b is preferably 1 mm or more in view of mechanical strength. If the thickness t2 is more than 5 mm, a high voltage is required for discharge, which is not preferable.

In order to reduce the corrosion of the dielectric layer 704b due to discharge, it is preferable that the second electrode roller 704 rotate, being circumferentially covered entirely with a dielectric. The second electrode roller 704 may be rotated by a drive part such as a motor (not graphically illustrated).

Next, a description is given of a configuration of oil-less toner, taking Toner A and Toner B as examples.

### [Manufacturing of Toner A]

A formulation of two types of binder resins, two kinds of release agents, and a coloring agent as indicated below was preliminarily mixed using a Henschel mixer (FM10B, manufactured by Mitsui Miike Kakoki Kaisha, Ltd.), and was then melted and kneaded using a two-axis extruder (PCM-30, manufactured by Ikegai Corp.) at a temperature of 100° C. to 130° C. A resultant kneaded material was cooled to room temperature and then coarsely pulverized using a hammer mill to sizes of 200 μm to 300 μm. Thereafter, using a supersonic jet pulverizer “Labo-Jet” manufactured by Nippon Pneumatic Mfg. Co., Ltd., the coarsely pulverized material was further finely pulverized by adjusting the pulverizing air pressure so that a weight-average particle size of 6.0±0.3 μm could be obtained. Thereafter, the finely pulverized material was classified using an air sifter (MDS-I, manufactured by Nippon Pneumatic Mfg. Co., Ltd.) while adjusting the louver angle so that a weight-average particle size of 6.8±0.3 μm could be obtained and the amount of fine powder of 4 μm or less was less than or equal to 10% by number, thereby obtaining toner matrix particles. Then, two kinds of additive agents indicated below were mixed with 100 parts by mass of the toner matrix particles using a Henschel mixer.

Binder Resin

Binder resin A: a polymer of terephthalic acid, bisphenol A propylene oxide adduct, and bisphenol A ethylene oxide adduct; softening point 110° C.; glass transition temperature 60° C.; acid number 5; Mn 2800; and Mw 8000, 50 parts by mass.

Binder resin B: a polymer of terephthalic acid, fumaric acid, trimellitic acid, bisphenol A propylene oxide adduct, and bisphenol A ethylene oxide adduct; softening point 200° C.; glass transition temperature 66° C.; acid number 12; Mn 2800; and Mw 45000, 50 parts by mass.

Mold Release Agent

Mold release agent A: carnauba wax, melting point 78° C., 3 parts by mass.

Mold release agent B: ethylenebisstearamide, melting point 145° C., 2 parts by mass.

Coloring agent: carbon black, 10 parts by mass.

Additive Agent

Inorganic fine particles A: SiO₂ (surface-hydrophobized with a silane coupling agent), average particle size 0.01 μm, and added amount 1.0 part by mass.

Inorganic fine particles B: TiO₂ (surface-hydrophobized with a silane coupling agent), average particle size 0.02 μm, and added amount 1.0 part by mass.

### [Manufacturing of Toner B]

Toner B was manufactured in the same way as Toner A using a formulation of two kinds of binder resins indicated below, a mold release agent, a coloring agent, and two kinds of additive agents.

Binder Resin

Binder resin A: a polymer of terephthalic acid, bisphenol A propylene oxide adduct, and bisphenol A ethylene oxide adduct; softening point 100° C.; glass transition temperature 65° C.; acid number 5 mgKOH/g, Mn 2800; and Mw 13000, 50 parts by mass.

Binder resin B: a polymer of terephthalic acid, fumaric acid, trimellitic acid, bisphenol A propylene oxide adduct, and bisphenol A ethylene oxide adduct; softening point 140° C.; glass transition temperature 65° C.; acid number 16; Mn 2400; and Mw 45000, 50 parts by mass.

Mold release agent: carnauba wax, melting point 78° C., 5 parts by mass

Coloring agent: carbon black, 10 parts by mass

Additive Agent:

Inorganic fine particles A: SiO₂ (surface-hydrophobized with a silane coupling agent), average particle size 0.01 μm, added amount 1.0 part by mass.

Inorganic fine particles B: TiO₂ (surface-hydrophobized with a silane coupling agent), average particle size 0.02 μm, added amount 1.0 part by mass.

The characteristic values of the polyester resin in the manufacturing of Toners A and B were measured as follows.

### [Softening Point of Resin]

Using a flow tester (CFT-500D, manufactured by Shimadzu Corporation), while heating 1 g of a sample at a temperature increase rate of 6° C./min., the sample is extruded out of a nozzle of 1 mm in diameter and 1 mm in length by applying a load of 1.96 MPa with a plunger. The amount of descent of the plunger in the flow tester is plotted with respect to temperature. The temperature at which half of the sample has flown out is determined as a softening point.

### [Glass Transition Point of Resin]

Using a differential scanning calorimeter (DSC210, manufactured by Seiko Denshi Kogyo Co., Ltd.), 0.01 g to 0.02 g of a sample is measured on an aluminum pan. The sample is subjected to a temperature increase to 200° C. and then cooled to 0° C. at a temperature decrease rate of 10° C./min. Then, the temperature of the sample is increased at a temperature increase rate of 10° C./min. The temperature at the intersection point of an extended line of a base line at or below a maximum heat-absorption peak temperature and a tangential line indicating the maximum inclination from a rising portion to the apex of the peak is determined as a glass transition point of resin.

### [Acid Number of Resin]

The acid number of resin is measured based on the method of JIS K0070. However, only the measurement solvent is changed from a mixture solvent of ethanol and ether determined by JIS K0070 to a mixture solvent of acetone and toluene (acetone:toluene=1:1 (volume ratio)).

[Content of a Low-Molecular-Weight Component of Resin with a Molecular Weight of 500 or Less]

A molecular weight distribution is measured by gel permeation chromatography (GPC). Ten ml of tetrahydrofuran is added to 30 mg of toner. After being subjected to mixing in a ball mill for 1 hour, the mixture is filtered using a fluororesin filter FP-200 having a pore size of 2 μm (manufactured by Sumitomo Electric Industries Ltd.) in order to remove insoluble components, thereby preparing a sample solution.

As an eluent, tetrahydrofuran is caused to flow at a flow rate of 1 ml/min. A column is stabilized in a constant-temperature bath at 40° C., into which 100 μl of the sample solution is poured for measurement. As an analyzing column, GMHLX+G3000HXL (manufactured by Toso Corporation) is used. For molecular weight calibration curves, several kinds of monodispersed polystyrene (2.63×10³, 2.06×10⁴, and 1.02×10⁵ manufactured by Toso Corporation, and 2.10×10³, 7.00×10³, and 5.04×10⁴ manufactured by GL Sciences Inc.) are prepared as standard samples.

The content (%) of a low-molecular-weight component having a molecular weight of 500 or less is calculated as the ratio of the area of a relevant region in a chart area obtained by an R1 (refractive index) detector to the entire chart area (area of relevant region/entire chart area).

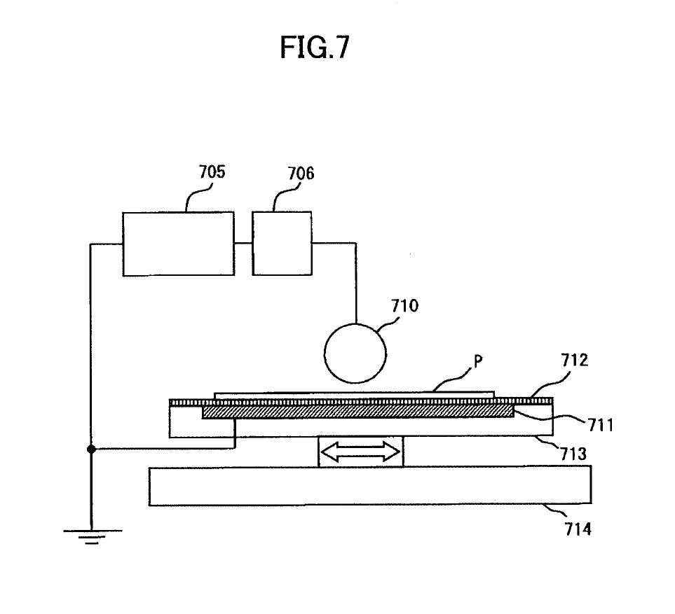

FIG. 7 is a schematic diagram illustrating a surface treating apparatus used in an experiment to confirm the effect of the discharge process in the image forming apparatus according to this embodiment. This surface treating apparatus may be used as the surface treating unit 70 incorporated in the image forming apparatus 1 (see FIG. 1) or a transfer material treating apparatus to be described below. In FIG. 7, a discharge electrode 710 as a first electrode member is a round bar of stainless steel having a diameter of 6 mm and a length of 300 mm. A grounding electrode 711 as a second electrode member is an aluminum plate of a thickness of 5 mm and a length of 300 mm in the axial direction of the discharge electrode 710 and is grounded. On the top side of the grounding electrode 711 on which the transfer paper P is placed, a dielectric 712 formed of a glass plate of 1 mm in thickness is provided. The grounding electrode 711 and the dielectric 712 are so fixed on an insulating base 713 so that there is a gap of 1 mm between the discharge electrode 710 and the dielectric 712. The insulating base 713 is caused to slide under the discharge electrode 710 in a direction perpendicular to the discharge electrode axis at a rate of 500 mm/s using an electric slider 714 (EZ limo, manufactured by Oriental Motor Co., Ltd.). A high-frequency high voltage was applied to the discharge electrode 710 using the high frequency generator 705 (CT-0212, manufactured by Kasuga Electric Works Ltd.) and the high-voltage transformer 706 (CT-T02W, manufactured by Kasuga Electric Works Ltd.), so that discharge was caused at power of 500 W while the transfer paper P was placed on the dielectric 712, thereby treating the transfer paper P. As the electrophotographic image forming apparatus, two types of color image forming apparatuses were used (image forming apparatus A: on-demand printing apparatus Pro C900 manufactured by Ricoh Company, Ltd. and image forming apparatus B: digital color MFP Imagio MP C4000, manufactured by Ricoh Company, Ltd.). Using each of the image forming apparatuses A and B, solid images of yellow (Y), magenta (M), cyan (C), and black (K) toners were formed on the transfer paper P as an object of treatment (processing).

Table 1 illustrates the results of performing surface treatment on the transfer paper P using the above-described laboratory (experiment) apparatus and thereafter measuring the fusing characteristics of the toner images output from the image forming apparatuses using oil-less toner. In Table 1, Transfer Paper A indicates the transfer paper P subjected to printing in the image forming apparatus A, and Transfer Paper B indicates the transfer paper P subjected to printing in the image forming apparatus B.

TABLE 1

| | Condition 1 | Condition 2 | Condition 3 |
|---|---|---|---|
| Transfer | Rank 1 | Rank 3 | Rank 5 |
| paper A | | | |
| Transfer | Rank 1 | Rank 1 | Rank 4 to 5 |
| paper B | | | |

The fusing characteristics of toner images were measured using a measurement method called “a tape peeling method” to evaluate adhesion to transfer paper. The tape peeling method was performed in the following steps (1), (2), and (3).

(1) Apply tape onto a target toner image.

(2) Hold an edge of the tape and remove the tape from (peel the tape off) the image.

(3) Evaluate the state of removal of toner from transfer paper by rank. Specifically, the state of no removal of toner from transfer paper is determined as “Rank 5”, the state of removal of entire toner from transfer sheet is determined as “Rank 1”, and the states in between are determined as Ranks 2, 3, and 4.

The measurement was performed under the following three conditions.

Condition 1: Normal condition of the apparatus.

Condition 2: Limit condition for increasing the fusing characteristic of the apparatus.

Condition 3: Normal condition of the apparatus with transfer paper pre-treated with a discharge part having a discharge function.

The “limit condition” means as follows. In order to improve the toner image fusing characteristic, the amount of heat applied to the toner may be increased. In general, the amount of heat is increased by “increasing the fusing temperature itself” or by “increasing time for applying heat.” However, there is an upper limit to “increasing the fusing temperature itself” because of, for example, the degradation of the rubber member of a fusing roller. With respect to “increasing time for applying heat,” there exists the lowest rate achievable by the apparatus. Thus, there are limit values based on the combination of the above-described two ways. The “limit condition” indicates image formation with such limit values.

As clearly indicated in Table 1, under Condition 2 as well, a satisfactory value was not obtained for the fusing characteristic according to the tape peeling method with respect to each of Transfer Paper A and Transfer Paper B. On the other hand, in the case of pre-treating the transfer paper P with the discharge unit having a discharge function as in Condition 3, sufficient adhesion was obtained even under the normal condition of the apparatus, and the performance (fusing characteristic) was dramatically improved to a satisfactory level.

Here, it is believed that sufficient adhesion is obtained even with the normal condition of the apparatus in the case of pre-treating the transfer paper P with the discharge unit having a discharge function because of the following mechanism. That is, in the fusing step, the wax contained in the oil-less toner is precipitated on a toner surface and therefore acts on the plane of contact with the fusing roller, thereby ensuring a releasing characteristic with respect to the toner. The wax is also precipitated on the plane of contact with the transfer paper P, which is also a toner surface. In the oil-less toner, this wax adversely affects adhesion to the transfer paper P, which is unfavorable for the fusing characteristic. An analysis of the images of Conditions 1 and 2 shows that the toner images after the fusing step are peeled off the surface of the transfer paper P like a film. That is, it is presumed that a sufficient amount of heat for melting toner is obtained while sufficient adhesion to the surface of the transfer paper P is not obtained. However, it is believed that by pre-treating the surface of the transfer paper P using the discharge unit having a discharge function, the wettability of the surface of the transfer paper P is improved so that sufficient adhesion is obtained even for the oil-less toner where wax is precipitated on the toner surface.

Thus, according to this embodiment, the surface treating unit 70 is configured to cause dielectric barrier discharge on or near the surface of the transfer paper P fed from the paper feed unit 43 or the manual feed tray 51 so that the surface of the transfer paper P is directly exposed to the dielectric barrier discharge. This surface treatment with dielectric barrier discharge makes it possible to increase the amount of energy provided to the surface of the transfer paper P dramatically (by one or more orders of magnitude) compared with the conventional case of using corona discharge. Further, due to the direct exposure to dielectric barrier discharge, the energy is provided to the surface of the transfer paper P with higher efficiency. In addition, compared with the conventionally-employed corona discharge, the dielectric barrier discharge makes it possible to generate a wider variety of active species in a region in contact with the surface of the transfer paper P. Accordingly, even in the case of forming a toner image on the transfer paper P using oil-less toner containing a release agent, it is possible to ensure an increase in the wettability of the surface of the transfer paper P with respect to the oil-less toner forming a toner image. Therefore, even in the case of forming a toner image on the transfer paper P using oil-less toner containing a release agent, sufficient adhesion for fusing the toner image onto the transfer paper P is obtained. Therefore, it is possible to ensure high fusing quality. Accordingly, there is good adhesion between the surface of the transfer paper P and a toner image, and the need for heat exclusively for obtaining adhesion is eliminated, thus reducing energy consumption. Further, usable transfer paper increases in kind. Thus, it is possible to provide quality that is satisfactory to customers.

In particular, according to this embodiment, dielectric barrier discharge is caused between the surface of the first electrode member 703 and the surface of the dielectric layer 704b of the second electrode roller 704 with the transfer paper P interposed in between. By utilizing this dielectric barrier discharge, it is possible to concentrate discharge in the gap G (FIG. 4) between the surface of the first electrode member 703 and the surface of the transfer paper P. Therefore, it is possible to ensure that discharge is caused on or near the surface of the transfer paper P with efficiency.

Further, according to this embodiment, the discharge part may include the first electrode roller 703 as an electrically conductive first electrode member facing the surface of the transfer paper P and extending in a direction to cross the moving direction of the transfer paper P; the second electrode roller 704 as the second electrode member including the roller-shaped core metal portion 704a as an electrically conductive member and the dielectric layer 704b formed on the surface of the core metal portion 704a, the second electrode roller 704 facing the first electrode roller 703 across the transfer paper P; and the voltage applying part configured to apply voltage between the first electrode roller 703 and the core metal portion 704a of the second electrode roller 704. The discharge part is configured to cause discharge between the first electrode roller 703 and the surface of the transfer paper P that is being conveyed on the second electrode roller 704 to treat (process) the surface of the transfer paper P.

Further, according to this embodiment, the voltage may be an AC voltage whose frequency is higher than or equal to 20 kHz and lower than or equal to 500 kHz. Therefore, no unpleasant or dissonant noise is generated during the discharge. Further, a low-resistance discharge channel due to residual ions is less likely to be formed in the gap G between the first electrode roller 703 and the transfer paper P on the second electrode roller 704. This allows a uniform discharge process, so that it is possible to prevent generation of high temperatures due to a flow of large current.

Further, according to this embodiment, the peak-to-peak voltage value of the AC voltage may be more than or equal to 5 kVp-p and less than or equal to 30 kVp-p per unit length (mm) of the thickness (size) of the gap g (FIG. 6) between the surface of the first electrode roller 703 and the surface of the second electrode roller 704 facing each other. This makes it possible to ensure that discharge is caused in the gap g and to prevent arc discharge from being caused between the first electrode roller 703 and its surrounding members.

Further, according to this embodiment, the material of the first electrode roller 703 may be stainless steel. Therefore, the first electrode roller 703 is less likely to be corroded by ozone generated during discharge.

Further, according to this embodiment, each of the first electrode roller 703 and the second electrode roller 704 may have a roller shape, and the second electrode roller 704 may be larger in diameter than the first electrode roller 703, so that the second electrode roller 704 may be considered to be a plane in a view from the first electrode roller 703. Therefore, it is possible to provide the surface of the transfer paper P with a wide and uniform discharge region (a region of so-called creeping discharge caused in the moving direction of the transfer paper P) at a position where the first electrode roller 703 and the second electrode roller 704 are opposite to each other, so that a uniform and efficient treatment effect is produced.

Further, according to this embodiment, by rotating the second electrode roller 704 whose outer peripheral surface is entirely covered with a dielectric layer in the circumferential direction, it is possible to reduce the corrosion of the dielectric layer 704b due to discharge.

Further, according to this embodiment, the dielectric layer 704b of the second electrode roller 704 may have a relative permittivity of 2 or more and 10 or less. This eliminates the need for a high voltage for discharge, and discharge is less likely to concentrate locally. The dielectric layer 704b of the second electrode roller 704 may have a thickness of 0.1 mm or more and 5 mm or less, so that it is possible to prevent generation of arc discharge due to breakdown, and the need for a high voltage for discharge is eliminated.

The above embodiments are described with reference to the surface treating unit (apparatus) 70 and the image forming apparatus 1 including the surface treating unit 70 according to the present invention, but are not limited to these illustrated. A surface treating apparatus according to the present invention may be configured as in other embodiments to be described below. Further, embodiments of the present invention may also be applied to an image forming system and a transfer material treating apparatus to be described below.

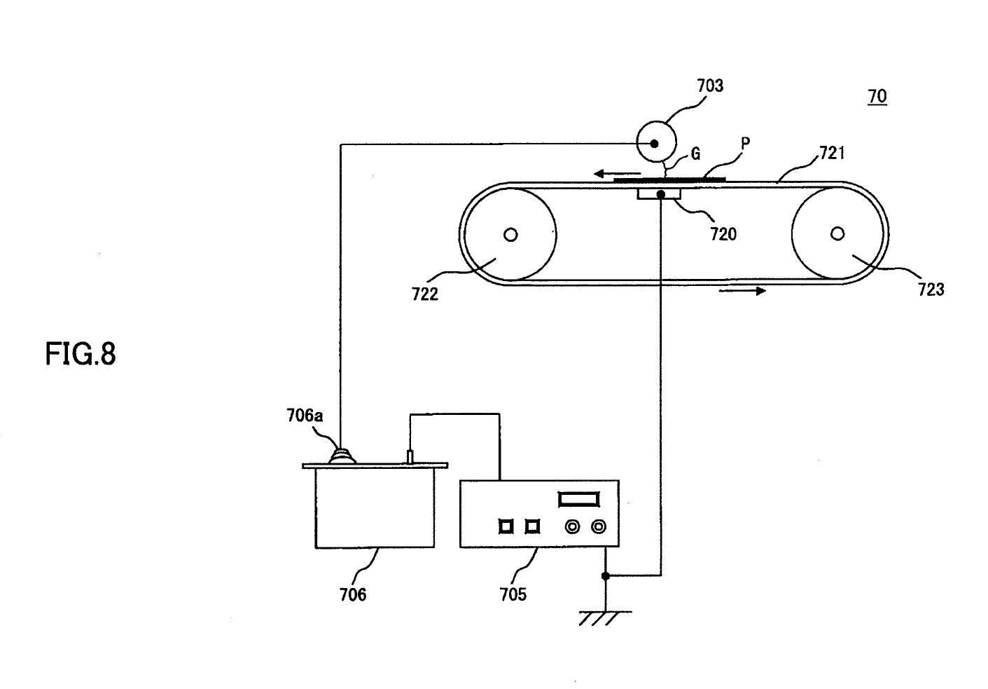

FIG. 8 is a schematic diagram illustrating a configuration of the surface treating unit (apparatus) 70 according to a second embodiment of the present invention. The surface treating unit 70 of this embodiment employs an electrode plate 720 formed of an electrically conductive material as a second electrode member that faces the first electrode roller 703. Examples of the material of the electrode plate 720 include aluminum (an aluminum plate). A dielectric belt 721 is wound around multiple rollers 722 and 723 with the bottom (inside) surface of the dielectric belt 721 in contact with the electrode plate 720. By causing one of the rollers 722 and 723 to serve as a driving roller to rotate the dielectric belt 721, it is possible to convey the transfer paper P, which is an object of treatment (processing), holding the transfer paper P on the dielectric belt 721. In this surface treating unit 70 as well, it is possible to perform surface treatment on the transfer paper P by causing discharge in the gap G between the surface of the transfer paper P that is being conveyed on the dielectric belt 721 and the first electrode roller 703 by applying a predetermined AC voltage to the first electrode roller 703.

In the surface treating unit 70 of FIG. 8, the electrode plate 720 may be replaced with an electrically conductive roller as the second electrode member opposite the first electrode roller 703. In this case, no dielectric layer may be provided on the surface of the electrically conductive roller as the second electrode member.

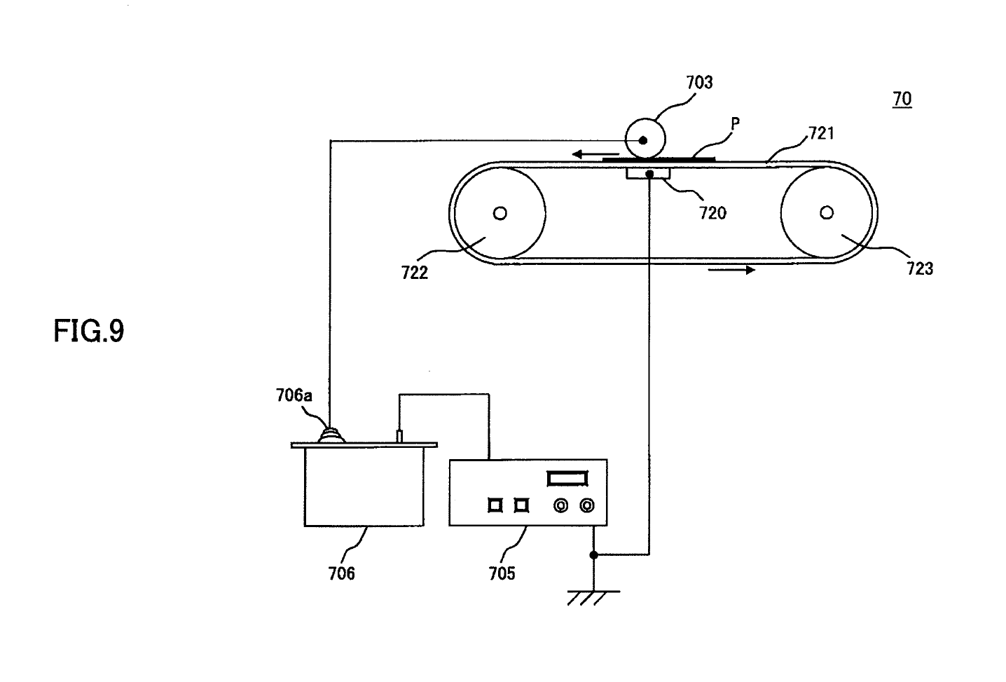

Further, as illustrated in FIG. 9, the first electrode roller 703 may be so provided as to come in contact with the surface of the transfer paper P on the dielectric belt 721.

According to the second embodiment as illustrated in FIG. 8 and FIG. 9, the dielectric belt 721 as a conveyor belt wound around the support rollers 722 and 723 and configured to convey the transfer paper P is provided as a transfer material transport unit. Further, the first electrode roller 703 as an electrically conductive first electrode member disposed opposite the surface of the transfer paper P that is being conveyed on the dielectric belt 721 and extending in a direction to cross the moving direction of the transfer paper P; and the electrode plate 720 as a second electrode member so disposed as to face the first electrode roller 703 across part of the dielectric belt 721 on which the transfer paper P is carried are provided as a discharge part. Further, a voltage applying part configured to apply voltage between the first electrode roller 703 and the electrode plate 720 is provided. The discharge part is configured to perform surface treatment on the transfer paper P by causing discharge between the first electrode roller 703 and the surface of the transfer paper P that is being conveyed in contact with the dielectric belt 721.

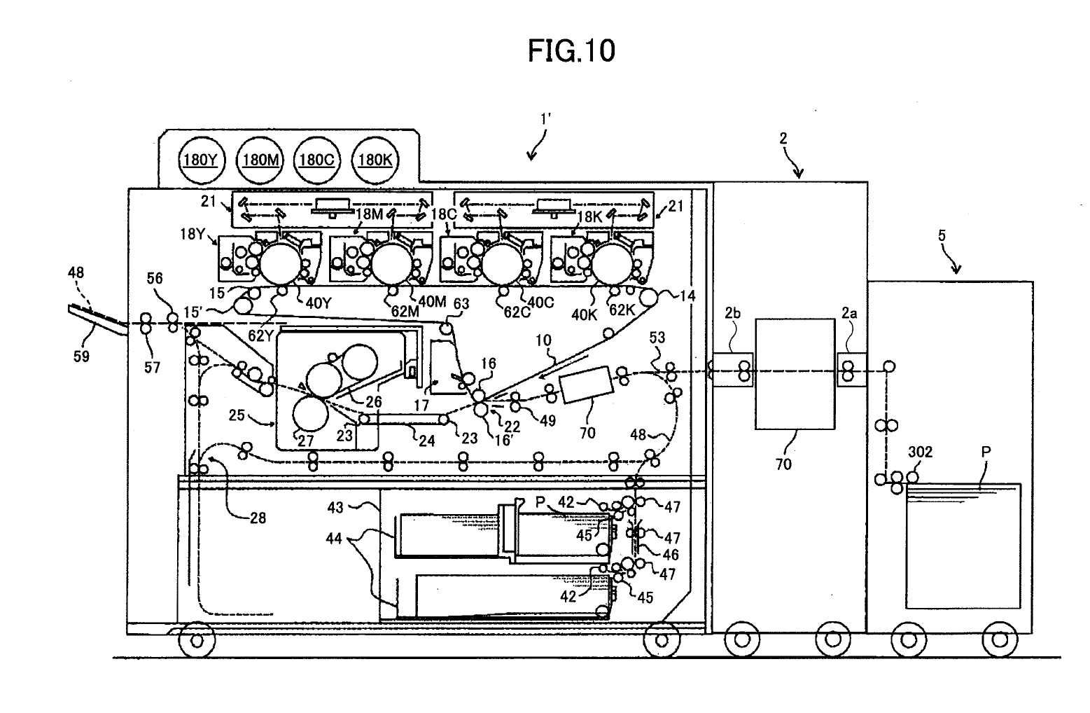

FIG. 10 is a schematic diagram illustrating a configuration of an image forming system according to a third embodiment of the present invention. The image forming system of this embodiment includes a combination of a common image forming apparatus 1′ without the surface treating unit as described above and a transfer material treating (processing) apparatus 2 as a peripheral device having the surface treating unit as described above. In the image forming apparatus 1′ of FIG. 10, various members or units that are the same as those of the image forming apparatus 1 of FIG. 1 may be used. In FIG. 10, the same members or units as those of the image forming apparatus 1 are referred to by the same reference numerals, and a description thereof is omitted. Referring to FIG. 10, in the image forming system, a paper feeder 5 serving as a transfer material feeder configured to output the transfer paper P (transfer material) to the transfer material treating apparatus 2 is provided as a peripheral device. The transfer material treating apparatus 2 includes a transfer material input part 2a to which the transfer paper P fed from the paper feeder 5 is input; the surface treating unit 70 that treats the surface of the transfer paper P input through the transfer material input unit, onto which surface a toner image is to be transferred; and a transfer material output unit 2b configured to output, to the image forming apparatus 1′, the transfer paper P subjected to surface treatment in the surface treating apparatus 70. The surface treating unit 70 in the transfer material treating apparatus 2 includes a discharge unit configured to cause discharge on or near the surface of the transfer paper P. The surface treating unit 70 may have the same configuration as that illustrated in FIG. 4, FIG. 5, FIG. 6, FIG. 8, or FIG. 9, for example.

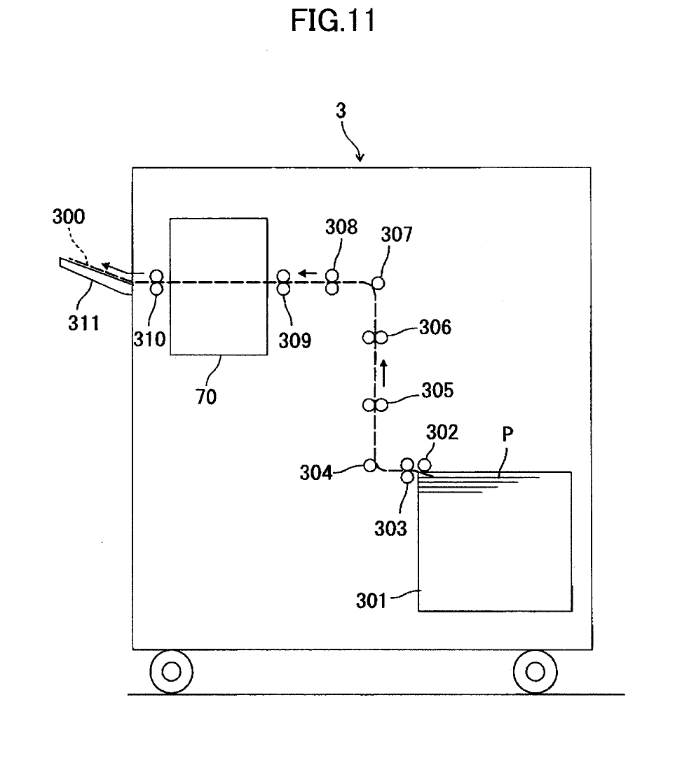

FIG. 11 is a schematic diagram illustrating a configuration of a transfer material treating apparatus 3 according to a fourth embodiment of the present invention. The transfer material treating apparatus 3 is an independently installable type, which may be installed independently of an image forming apparatus, which forms a toner image on a transfer material (an object of treatment), at a position away from where the image forming apparatus is installed. This transfer material treating apparatus 3 includes a paper feed cassette 301 as a transfer material feed part to feed the transfer paper P; the surface treating unit 70 configured to treat the surface of the transfer paper P fed from the paper feed cassette 301; and a paper output tray 311 as a transfer material output part onto which the transfer paper P subjected to surface treatment by the surface treating apparatus 70 is output. The paper feed cassette 301 accommodates (stores) a stack of sheets of transfer paper P. The transfer paper P at the top of the paper stack in the paper feed cassette 301 is fed out by the rotation of the paper feed roller 302. The transfer paper P fed out of the paper feed cassette 301 is conveyed to the surface treating unit 70 by paper feed rollers 303 and conveyance rollers 304 to 309. The transfer paper P subjected to a discharge process in and output from the surface treating unit 70 is output onto the paper output tray 311 serving as a placement base by a paper ejecting roller pair 310. According to this configuration, a transfer paper conveyance path 300 is formed from the paper feed position of the paper feed cassette 301 to the paper output tray 311. Further, according to this embodiment as well, the surface treating unit 70 includes a discharge part configured to cause discharge on or near the surface of the transfer paper P. For example, the surface treating unit 70 may have the same configuration as that illustrated in FIG. 4, FIG. 5, FIG. 6, FIG. 8, or FIG. 9. In the transfer material treating apparatus 3, when multiple sheets of the transfer paper P are set together in the paper feed cassette 301 and a user operates a process (treatment) start button in an operations part (not graphically illustrated), automatic feeding of the transfer paper P is started so that multiple sheets of the transfer paper P in the paper feed cassette 301 are sequentially fed one by one from the uppermost sheet. The fed sheets of the transfer paper P are then subjected to a predetermined discharge process in the surface treating unit 70, and the surface-treated sheets of the transfer paper P improved in wettability are successively output onto the paper output tray 311.

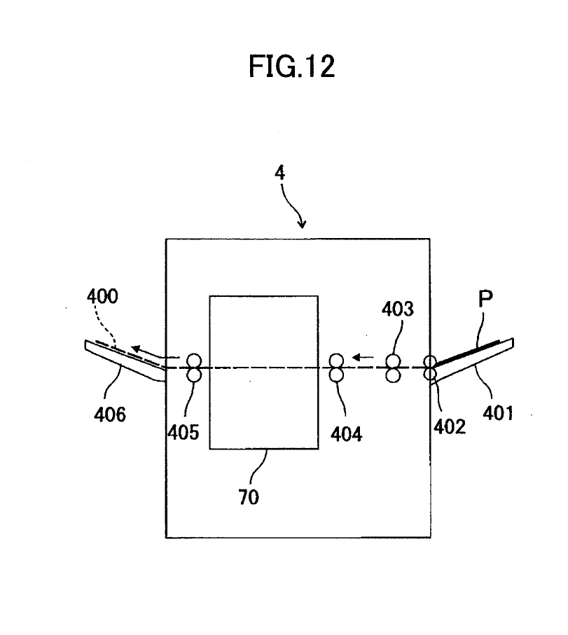

FIG. 12 is a diagram illustrating a configuration of a transfer material treating apparatus 4 according to a fifth embodiment of the present invention. Like the transfer material treating apparatus 3 illustrated in FIG. 9, the transfer material treating apparatus 4 is an independently installable type, which may be installed independently of an image forming apparatus. The transfer material treating apparatus 4 differs from the configuration illustrated in FIG. 11 in including a manual feed tray 401 as a transfer material feeder configured to feed the transfer paper P in place of the paper feed cassette 301. The transfer paper P set on the manual feed tray 401 is fed out by manual feed rollers 402 toward the surface treating unit 70 to be introduced into the surface treating unit 70 by conveyance rollers 403 and 404. The transfer paper P subjected to a discharge process and output by the surface treating unit 70 is output by a paper ejecting roller pair 405 onto a paper output tray 406 as a placement base. According to this configuration, a transfer paper conveyance path 400 is formed from the manual feed tray 401 to the paper output tray 406. Further, according to this embodiment as well, the surface treating unit 70 includes a discharge part configured to cause discharge on or near the surface of the transfer paper P. For example, the surface treating unit 70 may have the same configuration as that illustrated in FIG. 4, FIG. 5, FIG. 6, FIG. 8, or FIG. 9. In the transfer material treating apparatus 4 of this embodiment, multiple sheets of the transfer paper P are set on the manual feed tray 401, and based on the operation of a process (treatment) start button in an operation part (not graphically illustrated) or detection of the transfer paper P on the manual feed tray 401, automatic feeding of the transfer paper P on the manual feed tray 401 is started. Multiple sheets of the transfer paper P are subjected to a predetermined discharge process in the surface treating unit 70, and the surface-treated sheets of the transfer paper P improved in wettability are successively output onto the paper output tray 406. In particular, in the transfer material treating apparatus 4 according to this embodiment, since the transfer paper P may be placed on the manual feed tray 401, it is possible to treat (process) the transfer paper P on a sheet basis with ease.

In particular, the transfer material treating apparatus 3 or 4 according to the embodiment illustrated in FIG. 11 or FIG. 12 includes the paper feed cassette 301 or the manual feed tray 401 serving as a transfer material feed part to feed the transfer paper P; the paper feed rollers 303, the conveyance rollers 304 through 309, and the transfer paper conveyance path 300 or the conveyance rollers 403 and 404, the paper ejecting roller pair 405, and the transfer paper conveyance path 400 as a transfer material conveying part configured to convey the transfer paper P so that the surface of the fed transfer paper P passes through the discharge region of the discharge part of the surface treating unit 70; and the paper output tray 311 or the paper output tray 406 as a transfer material ejecting part onto which the transfer paper P that has passed through the discharge area is ejected. In the transfer material treating apparatus 3 or 4, it is possible to set multiple sheets of the transfer paper P before formation of a toner image on their surfaces using oil-less toner containing a release agent in the paper feed cassette 301 and successively treat (process) the sheets or to treat (process) the transfer paper P with ease by placing sheets of the transfer paper P one by one on the manual feed tray 401.

Further, according to the fourth and the fifth embodiment, the paper output tray 311 or 406 serving as a placement base on which the ejected sheets of the transfer paper P are stacked makes it possible to stock the sheets of the surface-treated transfer paper P.

Further, according to the transfer material treating apparatus 3 or 4 illustrated in FIG. 11 or 12, the manual feed tray 401 or the paper output tray 311 or 406 may be configured to be variable (adjustable) in height so as to be connectable to image forming apparatuses of other manufacturers. For example, the transfer material treating apparatus 3 or 4 may be provided with threaded (screw-type) leg members at its bottom, and by rotating the leg members, the overall height of the transfer material treating apparatus 3 or 4 may be adjusted to the paper feed position or the paper ejecting position of the image forming apparatus. Alternatively, the paper feed part, the paper output part, and the surface treating unit 70 may be integrated into a conveyance part, and the conveyance part may be vertically moved.

In the above-described embodiments, the transfer material, which is an object of treatment to be treated (processed) in the surface treating unit 70, is not limited to fiber material-based transfer paper, and may be a transfer material other than transfer paper, such as a plastic sheet for an OHP (overhead projector), as long as the transfer material allows formation of and fusing of a toner image on the transfer material. The same effects as those described above may be produced with respect to such a transfer material.

As toner for forming a toner image on the transfer material treatable in the surface treating unit 70 in the above-described embodiments, for example, electrophotography toner containing at least resin and a coloring agent as described below may be used.

### [Resin]

Examples of the resin include at least a binder resin. The binder resin is not limited in particular and may be suitably selected from commonly used resins. Examples of such resins include vinyl polymers of styrene-based monomers, acrylic-based monomers, methacrylic-based monomers, etc., copolymers of one or more kinds of these monomers, polyester-based polymers, polyol resins, phenol resins, silicone resins, polyurethane resins, polyamide resins, furan resins, epoxy resins, xylene resins, terpene resins, coumarane-indene resins, polycarbonate resins, and petroleum-based resins. Taking also mechanical strength into consideration, polyester resins are preferable.

Examples of styrene-based monomers include styrenes such as styrene, o-methylstyrene, m-methylstyrene, p-methylstyrene, p-phenylstyrene, p-ethyl styrene, 2,4-dimethylstyrene, p-n-amyl styrene, p-tert-butylstyrene, p-n-hexylstyrene, p-n-octylstyrene, p-n-nonylstyrene, p-n-decylstyrene, p-n-dodecylstyrene, p-methoxystyrene, p-chlorostyrene, 3,4-dichlorostyrene, m-nitrostyrene, o-nitrostyrene, and p-nitrostyrene, and their derivatives.

Example of acrylic-based monomers include acrylic acids such as acrylic acid, methyl acrylate, ethyl acrylate, propyl acrylate, n-butyl acrylate, isobutyl acrylate, n-octyl acrylate, n-dodecyl acrylate, 2-ethylhexyl acrylate, stearyl acrylate, 2-chloroethyl acrylate, and phenyl acrylate, and their esters.

Examples of methacrylic-based monomers include methacrylic acids such as methacrylic acid, methyl methacrylate, ethyl methacrylate, propyl methacrylate, n-butyl methacrylate, isobutyl methacrylate, n-octyl methacrylate, n-dodecyl methacrylate, 2-ethylhexyl methacrylate, stearyl methacrylate, phenyl methacrylate, dimethylaminoethyl methacrylate, and diethylaminoethyl methacrylate, and their esters.

Examples of other monomers that form vinyl polymers or copolymers include the following: (1) monoolefins such as ethylene, propylene, butylene, and isobutylene; (2) polyenes such as butadiene and isoprene; (3) vinyl halides such as vinyl chloride, vinyleden chloride, vinyl bromide, and vinyl fluoride; (4) vinyl esters such as vinyl acetate, vinyl propionate, and vinyl benzoate; (5) vinyl ethers such as vinyl methyl ether, vinyl ethyl ether, and vinyl isobutyl ether; (6) vinyl ketones such as vinyl methyl ketone, vinyl hexyl ketone, and methyl isopropenyl ketone; (7) N-vinyl compounds such as N-vinylpyrrole, N-vinylcarbazole, N-vinylindole, and N-vinylpyrrolidone; (8) vinyl naphthalines; (9) acrylic or methacrylic acid derivatives such as acrylonitrile, methacrylonitryl, and acrylamide; (10) unsaturated dibasic acids such as maleic acid, citraconic acid, itaconic acid, alkenyl succinic acid, fumaric acid, and mesaconic acid; (11) unsaturated dibasic acid anhydrides such as maleic acid anhydride, citraconic acid anhydride, itaconic acid anhydride, and alkenyl succinic acid anhydride; (12) monoesters of unsaturated dibasic acids, such as maleic acid monomethyl ester, maleic acid monoethyl ester, maleic acid monobutyl ester, citraconic acid monomethyl ester, citraconic acid monoethyl ester, citraconic acid monobutyl ester, itaconic acid monomethyl ester, alkenyl succinic acid monomethyl ester, fumaric acid monomethyl ester, and mesaconic acid monomethyl ester; (13) unsaturated dibasic acid esters such as dimethylmaleic acid and dimethylfumaric acid; (14) α,β-unsaturated acids such as crotonic acid and cinnamic acid; (15) α,β-unsaturated acid anhydrides such as crotonic anhydride and cinnamic anhydride; (16) monomers having a carboxyl group(s) such as anhydrides of the α,β-unsaturated acids and lower fatty acids, an alkenyl malonic acid, an alkenyl glutaric acid, an alkenyl adipic acid, and anhydrides and monoesters thereof; (17) hydroxyalkyl esters of acrylic acids or methacrylic acids such as 2-hydroxyethyl acrylate, 2-hydroxyethyl methacrylate and 2-hydroxypropyl methacrylate; and (18) monomers having a hydroxyl group such as 4-(1-hydroxy-1-methylbutyl)styrene and 4-(1-hydroxy-1-methylhexyl)styrene.

In the toner of the embodiments, vinyl polymers or copolymers of the binder resin may have a cross-linked structure where polymer chains are cross-linked by a cross-linker having 2 or more vinyl groups. Examples of cross-linkers used in such a case include aromatic divinyl compounds such as divinylbenzene and divinylnaphthalene. Examples of diacrylate compounds in which acrylates are bound together by an alkyl chain include ethylene glycol diacrylate, 1,3-butylene glycol diacrylate, 1,4-butanediol diacrylate, 1,5-pentanediol diacrylate, 1,6-hexanediol diacrylate, neopentyl glycol diacrylate, and those where the acrylate of the above compounds is replaced by methacrylate. Examples of diacrylate compounds in which acrylates are bound together by an alkyl chain including an ether bond(s) include diethyleneglycol diacrylate, triethylene glycol diacrylate, tetraethylene glycol diacrylate, polyethylene glycol #400 diacrylate, polyethylene glycol #600 diacrylate, dipropylene glycol diacrylate, and those where the acrylate of the above compounds is replaced by methacrylate.

In addition, examples of cross-linkers include diacrylate compounds and dimethacrylate compounds in which diacrylates and dimethacrylates, respectively, are bound together by a chain having an aromatic group and an ether bond(s). Examples of polyester diacrylates include MANDA (a product name, manufactured by Nippon Kayaku Co., Ltd.).

Examples of polyfunctional cross-linkers include pentaerythritol triacrylate, trimethylolethane triacrylate, trimethylolpropane triacrylate, tetramethylolmethane tetraacrylate, oligoester acrylate, those where the acrylate of the above compounds is replaced by methacrylate, triallyl cyanurate, and triallyl trimellitate.

The amount of the cross-linker used is preferably 0.01 to 10 parts by weight and, more preferably, 0.03 to 5 parts by mass per 100 parts by mass of other monomer components. Among these cross-linkable monomers, aromatic divinyl compounds (divinylbenzene in particular) and diacrylate compounds where acrylates are bound by a bonding chain having an aromatic group and one ether bond are preferable as resin for toner in terms of a fusing characteristic and anti-offset characteristic. Of these, such combinations of monomers as to form a styrene copolymer or a styrene-acryl copolymer are preferable.

Examples of polymerization initiators used for producing the above-described vinyl polymers or copolymers include 2,2′-azobisisobutyronitrile, 2,2′-azobis(4-methoxy-2,4-dimethylvaleronitrile), 2,2′-azobis(2,4-dimethylvaleronitrile), 2,2′-azobis(2-methylbutyronitrile), dimethyl-2,2′-azobisisobutyrate, 1,1′-azobis(1-cyclohexanecarbonitrile), 2-(carbamoylazo)-isobutyronitrile, 2,2′-azobis(2,4,4-trimethylpentane), 2-phenylazo-2′,4′-dimethyl-4′-methoxyvaleronitrile, 2,2′-azobis(2-methylpropane), ketone peroxides such as methyl ethyl ketone peroxide, acetyl acetone peroxide and cyclohexanone peroxide, 2,2-bis(tert-butyl peroxy)butane, tert-butyl hydroperoxide, cumenehydroperoxide, 1,13,3-tetramethyl butyl hydroperoxide, di-tert-butyl peroxide, tert-butyl cumyl peroxide, dicumyl peroxide, α-(tert-butylperoxy)isopropyl benzene, isobutyl peroxide, octanoyl peroxide, decanoyl peroxide, lauroyl peroxide, 3,5,5-trimethyl hexanoyl peroxide, benzoyl peroxide, m-tolyl peroxide, diisopropyl peroxydicarbonate, di-2-ethylhexyl peroxydicarbonate, di-n-propyl peroxydicarbonate, di-2-ethoxyethyl peroxycarbonate, diethoxy isopropyl peroxydicarbonate, di(3-methyl-3-methoxybutyl)peroxycarbonate, acetyl cyclohexyl sulfonyl peroxide, tert-butyl peroxyacetate, tert-butyl peroxyisobutyrate, tert-butylperoxy-2-ethylhexylate, tert-butyl peroxylaurate, tert-butyloxy benzoate, tert-butylperoxy isopropyl carbonate, di-tert-butyl peroxyisophthalate, tert-butylperoxy allyl carbonate, isoamyl peroxy-2-ethylhexanoate, di-tert-butylperoxy hexahydroterephthalate, and tert-butyl peroxyazelate.

When the binder resin is a styrene-acrylate resin, a resin having at least one peak in a molecular weight range of 3,000 to 50,000 (number-average molecular weight) and having at least one peak in a molecular weight range of 100,000 or more in a molecular weight distribution of tetrahydrofuran (THF) soluble components of the resin components by gel permeation chromatography (GPC) is preferable in terms of a fusing characteristic, an offset characteristic, and preservative quality. With respect to THF soluble components, a binder resin whose components having a molecular weight range of 100,000 or less are 50% to 90% is preferable, a resin having a main peak in a molecular weight range of 5,000 to 30,000 is more preferable, and a resin having a main peak in a molecular weight range of 5,000 to 20,000 is the most preferable.

When the binder resin is a vinyl polymer such as a styrene-acrylate resin, the acid number of the binder resin is preferably 0.1 mgKOH/g to 100 mgKOH/g, more preferably 0.1 mgKOH/g to 70 mgKOH/g, and still more preferably, 0.1 mgKOH/g to 50 mgKOH/g.

Examples of monomers that constitute the above-described polyester polymers include, as bivalent alcohols, ethylene glycol, propylene glycol, 1,3-butanediol, 1,4-butanediol, 2,3-butanediol, diethylene glycol, triethylene glycol, 1,5-pentanediol, 1,6-hexanediol, neopentyl glycol, 2-ethyl-1,3-hexanediol, bisphenol A hydride, and diols obtained by polymerization of bisphenol A and cyclic ethers such as ethylene oxide and propylene oxide.

It is preferable to combine trihydric or higher-hydric alcohol in order to cross-link the above-described polyester resins. Examples of trihydric or higher-hydric alcohols include sorbitol, 1,2,3,6-hexanetetrol, 1,4-sorbitan, pentaerythritol, dipentaerythritol, tripentaerythritol, 1,2,4-butanetriol, 1,2,5-pentatriol, glycerol, 2-methylpropane triol, 2-methyl-1,2,4-butanetriol, trimethylolethane, trimethylolpropane, and 1,3,5-trihydroxybenzene.

Examples of acid components that constitute the above-described polyester polymers include benzene dicarboxylic acids or anhydrides thereof such as a phthalic acid, an isophthalic acid, and a terephthalic acid; alkyl dicarboxylic acids or anhydrides thereof such as a succinic acid, an adipic acid, a sebacic acid, and an azelaic acid; unsaturated dibasic acids such as a maleic acid, a citraconic acid, an itaconic acid, an alkenyl succinic acid, a fumaric acid, and a mesaconic acid; and unsaturated dibasic acid anhydrides such as maleic anhydride, citraconic anhydride, itaconic anhydride, and alkenyl succinic anhydride. Examples of polyvalent (trivalent or higher) carboxylic acid components include a trimellitic acid, a pyromellitic acid, a 1,2,4-benzene tricarboxylic acid, a 1,2,5-benzene tricarboxylic acid, a 2,5,7-naphthalene tricarboxylic acid, 1,2,4-naphthalene tricarboxylic acid, 1,2,4-butane tricarboxylic acid, 1,2,5-hexane tricarboxylic acid, 1,3-dicarboxy-2-methyl-2-methylene carboxypropane, tetra(methylene carboxy)methane, 1,2,7,8-octane tetracarboxylic acid, empol trimeric acids, anhydrides thereof, and partially lower alkyl esters.

When the binder resin is a polyester resin, a resin having at least one peak in a molecular weight range of 3,000 to 50,000 in a molecular weight distribution of THF soluble components of the resin components is preferable in terms of a toner fusing characteristic and an offset characteristic. With respect to THF soluble components, a binder resin whose components having a molecular weight range of 100,000 or less are 60% to 100% is also preferable, and a resin having at least one peak in a molecular weight range of 5,000 to 20,000 is more preferable. This molecular weight distribution of the binder resin is measured by gel permeation chromatography (GPC) using THF as a solvent.

When the binder resin is a polyester resin, the acid number of the binder resin is preferably 0.1 mgKOH/g to 100 mgKOH/g, more preferably 0.1 mgKOH/g to 70 mgKOH/g, and still more preferably, 0.1 mgKOH/g to 50 mgKOH/g.

As the binder resin that may be used in the toner of the embodiments, a resin may be used that contains, in at least one of the vinyl polymer component and the polyester resin component, a monomer that may react with these resin components. Among the monomers that constitute the polyester resin component, examples of those that can react with vinyl polymers include unsaturated dicarboxylic acids such as a phthalic acid, a maleic acid, a citraconic acid, and an itaconic acid and anhydrides thereof. Examples of the monomers that constitute the vinyl polymer component include those having a carboxyl group or a hydroxyl group and esters of acrylic acids or methacrylic acids.

In the case of using polyester polymers or vinyl polymers in combination with another binder resin, it is preferable to contain 60 mass % or more of a resin where the acid number of the total binder resin is 0.1 mgKOH/g to 50 mgKOH/g.

The acid number of a binder resin component of the toner composition is determined by the following method, and the basic operation is based on JIS K-0070.

(1) A sample is used after removing additives other than a binder resin (a polymer component), or the acid numbers and the contents of components other than a binder resin and a cross-linked binder resin are determined in advance. Then, 0.5 g to 2.0 g of the crushed sample is precisely weighed, and the weight of the polymer component is determined as Wg. For example, in the case of measuring the acid number of a binder resin from toner, the acid number and the content of a coloring agent, a magnetic material or the like are separately determined, and the acid number of the binder resin is determined by calculations.

(2) The sample is put in a 300 ml beaker and is dissolved by adding 150 ml of a liquid mixture of toluene/ethanol (volume ratio=4/1).

(3) The liquid mixture is tiltrated with a potentiometric tiltrator using 0.1 mol/L of a KOH ethanol solution.

(4) The usage of the KOH solution in (3) is determined as S(ml). At the same time, the blank is measured and the usage of the KOH solution at this time is determined as B(ml). Then, the acid number is calculated using Eq. (1) as follows:

Acid number(mgKOH/g)=[(S−B)×f×5.61]/W, (1)

where f is a factor of KOH.

For the binder resin of toner and a composition containing the binder resin, the glass transition temperature (Tg) is preferably 35° C. to 80° C. and, more preferably, 40° C. to 75° C. in terms of the preservability of toner. If Tg is lower than 35° C., toner is likely to degrade in a high-temperature atmosphere, and an offset may be likely to occur during fusing. If Tg exceeds 80° C., the fusing characteristic may be degraded.

Toner may contain a magnetic material. Examples of magnetic materials include (1) magnetic iron oxides such as magnetite, maghemite and ferrite, and iron oxides containing other metallic oxides; (2) metals such as iron, cobalt and nickel, and alloys of these metals and metals such as aluminum, cobalt, copper, lead, magnesium, tin, zinc, antimony, beryllium, bismuth, cadmium, calcium, manganese, selenium, titanium, tungsten, vanadium and the like; and (3) mixtures of these.

Specific examples of the magnetic materials include Fe₃O₄, γ—Fe₂O₃, ZnFe₂O₄, Y₃Fe₅O₁₂, CdFe₂O₄, Gd₃Fe₅O₁₂, CuFe₂O₄, PbFe₁₂O, NiFe₂O₄, NdFe₂O, BaFe₁₂O₁₉, MgFe₂O₄, MnFe₂O₄, LaFeO₃, iron powder, cobalt powder, and nickel powder. These may used alone or in combination. Of these, fine powder of ferrosoferric oxide and fine powder of γ-iron sesquioxide are preferable.

In addition, magnetic iron oxides such as magnetite, maghemite, ferrite, etc., containing a foreign element or mixtures thereof may also be used. Examples of foreign elements include lithium, beryllium, boron, magnesium, aluminum, silicon, phosphorus, germanium, zirconium, tin, sulfur, calcium, scandium, titanium, vanadium, chromium, manganese, cobalt, nickel, copper, zinc and, gallium. Preferably, foreign elements are selected from magnesium, aluminum, silicon, phosphorus, and zirconium. The foreign element may be incorporated in the crystal lattices of the iron oxide or in the iron oxide as an oxide or be present on the surface of the iron oxide as an oxide or hydroxide. It is preferable that the foreign element be contained as an oxide.

The foreign element may be incorporated into particles by mixing salts of the foreign element at the time of producing the magnetic material and adjusting pH. Further, the foreign element may be precipitated on the surface of the particles by adjusting pH after the production of the magnetic particles or adding salts of the foreign element and adjusting pH.

The usage of the magnetic material is preferably 10 to 200 parts by mass and, more preferably, 20 to 150 parts by mass per 100 parts by mass of the binder resin. The number average particle size of the magnetic material is preferably 0.1 μm to 2 μm and, more preferably, 0.1 μm to 0.5 μm. The number average particle size may be determined by taking a magnified photograph of particles with a transmission electron microscope and measuring it with a digitizer or the like. The magnetic characteristics of the magnetic material are preferably a coercivity of 20 Oe to 150 Oe, a saturated magnetization of 50 emu/g to 200 emu/g, and a residual magnetization of 2 emu/g to 20 emu/g under application of 10 kOe. The magnetic material may be used as a coloring agent.

### [Coloring Agent]

The coloring agent contained in the toner is not limited in particular, and commonly used resin may be suitably selected and used. Examples of coloring agents include carbon black, nigrosine dyes, iron black, Naphthol Yellow S, Hansa Yellow (10G, 5G, G), cadmium yellow, yellow iron oxide, ocher, chrome yellow, titanium yellow, polyazo yellow, oil yellow, Hansa Yellow (GR, A, RN, R), Pigment Yellow L, Benzidine Yellow (G, GR), Permanent Yellow (NCG), Vulcan Fast Yellow (5G, R), Tartrazine Lake, Quinoline Yellow Lake, Anthrazane Yellow BGL, Isoindolinone Yellow, red ochre, red lead, vermilion lead, cadmium red, cadmium mercury red, antimony vermilion, Permanent Red 4R, Para Red, Fire Red, p-chlor-o-nitroaniline red, Lithol Fast Scarlet G, Brilliant Fast Scarlet, Brilliant Carmine BS, Permanent Red (F2R, F4R, FRL, FRLL, F4RH), Fast Scarlet VD, Vulcan Fast Rubine B, Brilliant Scarlet G, Lithol Rubine GX, Permanent Red F5R, Brilliant Carmine 6B, Pigment Scarlet 3B, Bordeaux 5B, Toluidine Maroon, Permanent Bordeaux F2K, Helio Bordeaux BL, Bordeaux 10B, Bon Maroon Light, Bon Maroon Medium, Eosin Lake, Rhodamine Lake B, Rhodamine Lake Y, Alizarine Lake, Thioindigo Red B, Thioindigo Maroon, oil red, quinacridone red, pyrazolone red, polyazo red, chrome vermilion, benzidine orange, perynone orange, oil orange, cobalt blue, cerulean blue, Alkali Blue Lake, Peacock Blue Lake, Victoria Blue Lake, metal-free phthalocyanine blue, phthalocyanine blue, Fast Sky Blue, Indanthrene Blue (RS, BC), indigo, ultramarine, Prussian blue, anthraquinone blue, Fast Violet B, Methyl Violet Lake, cobalt violet, manganese violet, dioxane violet, anthraquinone violet, chrome green, zinc green, chromium oxide, viridian, emerald green, Pigment Green B, Naphthol Green B, Green Gold, Acid Green Lake, Malachite Green Lake, phthalocyanine green, anthraquinone green, titanium oxide, zinc oxide, lithopone, and mixtures of these coloring agents.

The content of the coloring agent contained is preferably 1% by mass to 15% by mass and, more preferably, 3% by mass to 10% by mass of the toner.

Further, the coloring agent used in the toner according to the embodiments may be compounded with resin and used as a master batch. Examples of the binder resin contained in the master batch or kneaded with the master batch include, in addition to the above-mentioned modified and unmodified polyester resins, polymers of styrene or substituted styrene, such as polystyrene, poly-p-chlorostyrene and polyvinyl toluene; styrene copolymers such as styrene-p-chlorostyrene copolymer, styrene-propylene copolymer, styrene-vinyl toluene copolymer, styrene-vinylnaphthalene copolymer, styrene-methyl acrylate copolymer, styrene-ethyl acrylate copolymer, styrene-butyl acrylate copolymer, styrene-octyl acrylate copolymer, styrene-methyl methacrylate copolymer, styrene-ethyl methacrylate copolymer, styrene-butyl methacrylate copolymer, styrene-α-chlor-methyl methacrylate copolymer, styrene-acrylonitrile copolymer, styrene-vinyl methyl ketone copolymer, styrene-butadiene copolymer, styrene-isoprene copolymer, styrene-acrylonitrile-indene copolymer, styrene-maleic acid copolymer, and styrene-maleic acid ester copolymer; polymethyl methacrylate; polybutyl methacrylate; polyvinyl chloride; polyvinyl acetate; polyethylene; polypropylene; polyesters; epoxy resins; epoxy polyol resins; polyurethane; polyamides; polyvinyl butyral; polyacrylic acid resins; rosins; modified rosins; terpene resins; aliphatic or alicyclic hydrocarbon resins; aromatic petroleum resins; chlorinated paraffins; and paraffin waxes. These may be used alone or in combination.

The master batch may be obtained by mixing and kneading a resin and a coloring agent for the master batch with application of a high shearing force. At this point, an organic solvent may be used in order to increase the interaction between the coloring agent and the resin. Further, a so-called flushing method, which mixes and kneads water-containing aqueous paste of a coloring agent with a resin and an organic solvent, transfers the coloring agent to the resin side, and removing water and the components of the organic solvent, may be suitably used because the flushing method allows the wet cake of the coloring agent to be used as it is without drying. For the mixing and kneading, a high shear dispersion apparatus such as a three-roll mill may be suitably used.

The usage of the master batch is preferably 0.1 parts by mass to 20 parts by mass per 100 parts by mass of the binder resin.

Preferably, the resin for the master batch is used with the coloring agent dispersed at an acid value of 30 mgKOH/g or less and an amine value of 1 to 100. More preferably, the resin for the master batch is used with the coloring agent dispersed at an acid value of 20 mgKOH/g or less and an amine value of 10 to 50. If the acid value exceeds 30 mgKOH/g, the charge characteristic under high humidity may decrease and the pigment dispersibility may also be insufficient. The pigment dispersibility may be insufficient as well if the amine value is less than 1 or exceeds 100. The acid value may be measured by the method according to JIS K0070. The amine value may be measured by the method according to JIS K7237.

A dispersant for the toner is preferably highly mutually soluble with the binder resin in terms of pigment dispersibility. Specific examples of commercially available dispersants include AJISPER PB-821 and AJISPER PB-822 (manufactured by Ajinomoto Fine-Techno Co., Inc.), Disperbyk-2001 (manufactured by BYK-Chemie GmbH), and EFKA-4010 (manufactured by EFKA Chemicals BV).

The dispersant is preferably blended at a proportion of 0.1% by mass to 10% by mass with respect to the coloring agent in the toner. If the blending proportion is less than 0.1% by mass, the pigment dispersibility may be insufficient. If the blending proportion exceeds 10% by mass, the charge characteristic under high humidity may be reduced.

The weight average molecular weight of the dispersant is, in terms of the molecular weight of a main peak local maximum value in the styrene conversion weight according to gel permeation chromatography, preferably 500 to 100,000, and more preferably, 3,000 to 100,000 from the viewpoint of pigment dispersibility. In particular, the weight average molecular weight of the dispersant is preferably 5,000 to 50,000 and, most preferably, 5,000 to 30,000. If the molecular weight is less than 500, an increase in the polarity may reduce the dispersibility of the coloring agent. If the molecular weight exceeds 100,000, an increase in the affinity with the solvent may decrease the dispersibility of the coloring agent.

The added amount of the dispersant is preferably 1 to 200 parts by mass and, more preferably, 5 to 80 parts by mass per 100 parts by mass of the coloring agent. If the added amount is less than 1 part by mass, the dispersion performance may decrease. If the added amount exceeds 200 parts by mass, the charge characteristic may decrease.

### [Wax]

As described above, the toner of a toner image on the transfer material that may be treated with the surface treating unit 70 according to the above-described embodiments may include wax along with a binder resin and a coloring agent.

The wax is not limited in particular, and commonly used waxes may be suitably selected and used. Examples of the wax include aliphatic hydrocarbon waxes such as low-molecular-weight polyethylene, low-molecular-weight polypropylene, polyolefin wax, microcrystalline wax, paraffin wax, and Sasol wax; oxides of aliphatic hydrocarbon waxes such as oxidized polyethylene wax and block copolymers thereof; botanical waxes such as candelilla wax, carnauba wax, Japan wax, and jojoba wax; animal waxes such as bees wax, lanolin, and whale wax; mineral waxes such as ozokerite, ceresin, and petrolatum; waxes containing a fatty acid ester as a main component, such as wax of montanic acid esters and castor wax; and partially or wholly deoxidized fatty acid esters such as deoxidized carnauba wax.

Examples of the wax further include saturated straight fatty acids such as a palmitic acid, a stearic acid, a montanic acid, and straight alkyl carboxylic acids further having a straight alkyl group; unsaturated fatty acids such as a brassidic acid, an eleostearic acid, and a parinaric acid; saturated alcohols such as stearyl alcohol, eicosyl alcohol, behenyl alcohol, carnaubil alcohol, ceryl alcohol, mesilyl alcohol, and long-chain alkyl alcohol; polyalcohols such as sorbitol; fatty acid amides such as linoleic acid amide, olefinic acid amide, and lauric acid amide; saturated fatty acid bisamides such as methylene bis-capric acid amide, ethylene bis-lauric acid amide, methylene bis-stearic acid amide, ethylene bis-stearic acid amide, and hexamethylene bis-stearic acid amide; unsaturated fatty acid amides such as ethylene bisoleic acid amide, hexamethylene bisoleic acid amide, N,N′-dioleyl adipic acid amide, and N,N′-dioleyl sebacic acid amide; aromatic bisamides such as m-xylene bis-stearic acid amide and N,N′-distearyl isophthalic acid amide; metallic salts of fatty acids such as calcium stearate, calcium laurate, zinc stearate, and magnesium stearate; waxes having an aliphatic hydrocarbon wax grafted using a vinyl monomer such as styrene and an acrylic acid; partially esterified compounds of polyalcohol and a fatty acid such as behenic acid monoglyceride; and methyl ester compounds having a hydroxyl group obtained by hydrogenating a vegetable oil.

More preferable examples of the wax include polyolefin obtained by radical-polymerizing olefin under high pressure; polyolefin obtained by purifying a low-molecular-weight by-product obtained in the polymerization of high-molecular-weight polyolefin; polyolefin polymerized under low pressure using a catalyst such as a Ziegler catalyst or a metallocene catalyst; polyolefin polymerized using radiation, electromagnetic waves, or light; low-molecular-weight polyolefin obtained by thermally decomposing high-molecular-weight polyolefin; paraffin wax; microcrystalline wax; Fischer-Tropsch wax; synthetic hydrocarbon waxes synthesized by a Synthol process, a Hydrocol process, an Arge process, or the like; synthetic waxes having a compound of one carbon atom as a monomer; hydrocarbon waxes having a functional group such as a hydroxyl group or a carboxyl group; a mixture of a hydrocarbon wax and a hydrocarbon wax having a functional group; and waxes where the above-described waxes as matrixes are grafted by a vinyl monomer such as styrene, ester maleate, acrylate, methacrylate, or maleic anhydride.

Further, the above-described waxes may have a molecular weight distribution sharpened using a press sweating process (method), a solvent method, recrystallization, vacuum distillation, supercritical gas extraction, or a solution crystallization method, or have low-molecular-weight solid fatty acids, low-molecular-weight solid alcohols, low-molecular-weight solid compounds or other impurities removed. These waxes are also suitably used.

The melting point of the wax is preferably 70° C. to 140° C. and, more preferably, 70° C. to 120° C. in order to balance the fusing characteristic and the anti-offset characteristic. If the melting point is lower than 70° C., the blocking resistance may be reduced. If the melting point exceeds 140° C., the anti-offset effect is less likely to be produced.

Further, two or more different kinds of waxes may be used in combination to simultaneously develop both the plasticizing action and the releasing action, which are actions of wax. Examples of waxes having the plasticizing action include those having a low melting point, those having a branched molecular structure, and those having a polar group in the structure.

Examples of waxes having the releasing action include those having a high melting point. Examples of their structures include a straight molecular structure and a nonpolar molecular structure having no functional group. Examples of their usage include combinations of two or more different kinds of waxes whose difference in wax melting point is 10° C. to 100° C. and combinations of polyolefin and grafted polyolefin.

In the case of selecting two kinds of waxes, if the waxes are similar in structure, the wax relatively lower in melting point exerts the plasticizing action and the wax relatively higher in meting point exerts the releasing action. At this point, if the difference in melting point is 10° C. to 100° C., the functional separation effectively occurs. If the difference is less than 10° C., the functional separation effect may be less likely to occur. If the difference exceeds 100° C., the functions due to interaction may be less likely to be emphasized. At least one of the waxes preferably has a melting point of 70° C. to 120° C. and more preferably has a melting point of 70° C. to 100° C. because in such a case, the functional separation effect tends to be produced more easily.

Of the waxes, those having a branched molecular structure, those having a polar group such as a functional group, and those modified by a component different from a main component relatively exert the plasticizing action, and those having a structure closer to a straight-chain structure, those having no polarity without a functional group, and those unmodified and straight relatively exert the releasing action. Examples of preferable combinations of waxes include a combination of polyethylene homopolymer or copolymer having ethylene as a main component and polyolefin homopolymer or copolymer having olefin other than ethylene as a main component; a combination of polyolefin and grafted polyolefin; a combination of a hydrocarbon wax and an alcohol wax, a fatty acid wax, or an ester wax; a combination of Fischer-Tropsch wax or a polyolefin wax and a paraffin wax or a microcrystalline wax; a combination of Fischer-Tropsch wax and a polyolefin wax; a combination of a paraffin wax and a microcrystalline wax; and a combination of a hydrocarbon wax and a carnauba wax, a candelilla wax, a rice bran wax, or a montan wax.

In each case (combination), in view of facilitating a balance between the toner preservability and fusing property, it is preferable that the peak-top temperature of the maximum peak be within the range of 70° C. to 110° C. and it is more preferable that the maximum peak be within the range of 70° C. to 110° C. in the endothermic peaks observed in a differential scanning calorimetry (DSC) measurement of the toner.

The total content of the wax is preferably 0.2 to 20 parts by mass and, more preferably, 0.5 to 10 parts by mass per 100 parts by mass of the binder resin.

With respect to the wax contained in the toner according to the embodiments, the peak-top temperature of the maximum one of the endothermic peaks of the wax observed by DSC is determined as the melting point of the wax.

According to the embodiments, it is preferable to conduct a DSC measurement of the wax or the toner using a high-precision intraheater power-compensation type differential scanning calorimeter as a DSC measurement apparatus. As a measurement method, a method according to JIS K7121 is employed, for example. The DSC curve used is that measured when the temperature is increased at a temperature velocity of 10° C./min. after recording a pre-history by increasing and decreasing temperature one time each, for example.

### [Charge Control Agent]

A charge control agent for the toner is not limited in particular, and may be suitably selected from those known in accordance with purposes. Materials that are colorless or close to white are preferable because a colored material may result in a change in color tone. Examples of charge control agents include triphenylmethane dyes, molybdic acid chelate pigments, rhodamine dyes, alkoxyamines, quaternary ammonium salts (including fluorine-modified quaternary ammonium salts), alkylamides, elementary substance or compounds of phosphorus, elementary substance or compounds of tungsten, fluorine-containing active agents, metal salts of salicylic acid, and metal salts of salicylic acid derivatives. These may be used alone or in combination.

The charge control agent added in the toner may be used for, for example, adjusting the charge property of the toner to control a charge property difference in an environment where the charge property may greatly vary, such as a high-temperature, high-humidity environment or a low-temperature, low-humidity environment, or to control variations in charge amount among toner particles.

Commercially available produces may be used for the charge control agent. Examples of commercially available produces include BONTRON P-51 (quaternary ammonium salt), BONTRON E-82 (metal complex of oxynaphthoic acid), BONTRON E-84 (metal complex of salicylic acid), and BONTRON E-89 (phenolic condensation product) (each a product of Orient Chemical Industries Co., Ltd.); TP-302 and TP-415 (molybdenum complex of quaternary ammonium salt) (each a product of Hodogaya Chemical Co., Ltd.); COPY CHARGE PSY VP2038 (quaternary ammonium salt), COPY BLUE PR (triphenylmethane derivative), COPY CHARGE NEG VP2036 and COPY CHARGE NX VP434 (quaternary ammonium salt) (each a product of Hoechst AG); LRA-901 and LR-147 (boron complex) (each a product of Japan Carlit Co., Ltd.); quinacridone pigments; azo pigments; and polymeric compounds having a functional group such as sulfonic group, carboxyl group, or quaternary ammonium salt.

The charge control agent may be dissolved and/or dispersed after being melted and kneaded with the master batch. Alternatively, the charge control agent may be directly added to the organic solvent together with the various components of the toner when dissolved and/or dispersed, or the charge control agent may be fixed onto the toner surface after the toner particles have been manufactured.

The charge control agent content of the toner differs depending on the kind of the binder resin, the presence or absence of additives, the dispersing method, etc., and may not be generalized. For example, the charge control agent content is preferably 0.1 parts by mass to 10 parts by mass and, more preferably, 0.2 parts by mass to 5 parts by mass per 100 parts by mass of the binder resin. If the content is less than 0.1 parts by mass, the charge controllability may not be obtained. If the content exceeds 10 parts by mass, the chargeability of the toner may become excessively high to reduce the effect of the main charge control agent, so that a developer may have increased electrostatic attraction with respect to a development roller to incur a decrease in the fluidity of the developer or a decrease in image density.

### [Fluidity Improving Agent]

A fluidity improving agent may be added to the toner of the embodiments. The fluidity improving agent is added to the surface of the toner to improve the fluidity of the toner (make it easier for the toner to flow). Examples of the fluidity improving agent include fluorine resin powders such as carbon black, fine powder of vinylidene fluoride, and fine powder of polytetrafluoroethylene; fine powders of silica such as wet processed silica and dry processed silica; fine powder of non-oxidized titanium; fine powder of alumina; and treated silica, treated titanium oxide and treated alumina where the above fine powders are surface-treated with a silane coupling agent, titanium coupling agent, or silicone oil. Of these, fine powder of silica, fine powder of non-oxidized titanium, and fine powder of alumina are preferable, and treated silica where these fine powders are surface-treated with a silane coupling agent or silicone oil are more preferable.

The particle size of the fluidity improving agent is preferably 0.001 μm to 2 μm and, more preferably, 0.002 μm to 0.2 μm as an average primary particle size.

The fine powders of silica are fine powders produced by oxidizing the gas phase of silicon halides, and are so-called dry processed silica or fumed silica.

Example of commercially available silica fine powders produced by gas-phase oxidation of silicon halides include AEROSIL-130, AEROSIL-300, AEROSIL-380, AEROSIL-TT600, AEROSIL-MOX170, AEROSIL-MOX80, and AEROSIL-COK84 (each a product of Nippon Aerosil Co., Ltd.); Ca—O—SiL-M-5, Ca—O—SiL-MS-7, Ca—O—SiL-MS-75, Ca—O—SiL-HS-5, and Ca—O—SiL-EH-5 (each a product of CABOT K.K.); Wacker HDK-N20 V15, Wacker HDK-N20E, Wacker HDK-T30, and Wacker HDK-T40 (each a product of Wacker-Chemie GmbH); D-C FineSilica (a product of Dow Corning Toray Co., Ltd.); and Franso 1 (a product of Fransil K.K.).

In addition, treated silica fine powders, which are hydrophobized silica fine powders produced by gas-phase oxidation of silicon halides, are more preferable. Among the treated silica fine powders, those having silica fine powder treated so that the degree of hydrophobization measured by a methanol titration test preferably indicates 30% to 80% are particularly preferable. Hydrophobization is achieved by chemically or physically treating silica fine powders with an organic silicon compound(s) which reacts with the silica fine powders or physically adsorbs to the silica fine powders. As a preferable method, silica fine powders produced by oxidizing the gas phase of silicon halides may be treated with an organic silicon compound(s).

Examples of the organic silicon compound include hydroxypropyl trimethoxysilane, phenyltrimethoxysilane, n-hexadecyltrimethoxysilane, n-octadecyltrimethoxysilane, vinylmethoxysilane, vinyltriethoxysilane, vinyltriacetoxysilane, dimethylvinylchlorosilane, divinylchlorosilane, γ-methacryloxypropyltrimethoxysilane, hexamethyldisilane, trimethylsilane, trimethylchlorosilane, dimethyldichlorosilane, methyltrichlorosilane, allyldimethylchlorosilane, allylphenyldichlorosilane, benzyldimethylchlorosilane, bromomethyldimethylchlorosilane, α-chloroethyltrichlorosilane, β-chloroethyltrichlorosilane, chloromethyldimethylchlorosilane, triorganosilyl mercaptan, trimethylsilyl mercaptan, triorganosilyl acrylate, vinyldimethylacetoxysilane, dimethylethoxysilane, trimethylethoxysilane, trimethylmethoxysilane, methyltriethoxysilane, isobutyltrimethoxysilane, dimethyldimethoxysilane, diphenyldiethoxysilane, hexamethyldisiloxane, 1,3-divinyltetramethyldisiloxane, 1,3-diphenyltetramethyldisiloxane, and dimethylpolysiloxane that has 2 to 12 siloxane units per molecule and contains 0 to 1 hydroxyl group attached to Si in the unit located at each end. Examples of the organic silicon compound further include silicone oils such as dimethyl silicone oil. These may be used alone or in combination.

The number average particle size of the fluidity improving agent is preferably 5 nm to 100 nm and, more preferably, 5 nm to 50 nm. Further, the specific surface area by nitrogen adsorption, measured by the BET (Brunauer-Emmerit-Teller) method, is preferably 30 m²/g or more and, more preferably, 60 m²/g to 400 m²/g.

The specific surface area of the surface-treated fine powders is preferably 20 m²/g or more and, more preferably, 40 m²/g to 300 m²/g. The applied amount of these fine powders is preferably 0.03 to 8 parts by mass per 100 parts by mass of toner particles.

Further, to the toner of the embodiments, it is possible to add other additives as required, such as various metallic soaps; fluorine surfactants; dioctyl phthalate; conductivity imparting agents such as tin oxide, zinc oxide, carbon black, and antimony oxide; and inorganic fine powders of titanium oxide, aluminum oxide, and alumina in order to protect a electrostatic latent image carrying body and a carrier, to improve the cleaning characteristic, to control the thermal property, the electrical property, and the physical property, to control resistance, to control the softening point, and to improve the fusing ratio. These inorganic fine powders may be hydrophobized as required. Further, it is possible to use, as image development improving agents, small amounts of lubricants such as polytetrafluoroethylene, zinc stearate, and polyvinylidene-fluoride; abrasives such as cesium oxide, silicon carbide, and strontium titanate; anticaking agents; and white microparticles and black microparticles opposite in polarity to the toner particles.

In order to control the charge amount, it is also preferable to treat these additives with silicone varnish, various modified silicone varnishes, silicone oil, various modified silicone oils, silane coupling agents, silane coupling agents having a functional group(s), treatment agents such as other organic silicon compounds, or various other treatment agents.

Further, in preparing a developer, in order to improve the fluidity, the preservability, the developing property, and the transfer property of the developer, inorganic fine particles such as the aforementioned hydrophobic silica fine particles may further be added and mixed. For the mixing of an external additive, a common mixer for powder may be suitably selected and used. The mixer is preferably equipped with a jacket and the like so that the internal temperature of the mixer is allowed to be adjusted. To change the history of a load applied to the external additive, the external additive may be added in the middle or gradually. The number of revolutions, the rolling speed, the mixing time, and the temperature of the mixer may also be changed. A heavy load may be applied initially and then a relatively light load may be applied to the external additive, or vice versa.

Examples of the mixer include a V-type mixer, a locking mixer, a Loedige mixer, a Nauter mixer, and a Henshel mixer.

The method of further controlling the shape of the toner is not limited in particular, and may be suitable selected in accordance with purposes. Examples of the method include pulverizing a melted and kneaded toner material containing a binder resin and a coloring agent and mechanically controlling the toner shape using a hybridizer or a mechanofusion; a so-called spray-dry method that obtains spherical toner particles by dissolving or dispersing a toner material into a solvent in which the toner binder is soluble and subsequently removing the solvent using a spray-dry apparatus; and making spherical toner particles by heating toner in an aqueous medium.

As the external additive, inorganic fine particles may be suitably used. Examples of inorganic fine particles include those of silica, alumina, titanium oxide, barium titanate, magnesium titanate, calcium titanate, strontium titanate, zinc oxide, tin oxide, silica sand, clay, mica, wollastonite, diatomaceous earth, chromium oxide, cerium oxide, red iron oxide, antimony trioxide, magnesium oxide, zirconium oxide, barium sulfate, barium carbonate, calcium carbonate, silicon carbide, and silicon nitride. The primary particle size of the inorganic fine particles is preferably 5 nm to 2 μm and, more preferably, 5 nm to 500 nm. The specific surface area of the inorganic fine particles measured by the BET method is preferably 20 m²/g to 500 m²/g. The ratio of use of the inorganic fine particles to the toner is preferably 0.01 mass % to 5 mass % and, more preferably, 0.01 mass % to 2.0 mass %.

Other examples of the external additive include polymeric fine particles such as polymer fine particles of polystyrene obtained by soap-free emulsification polymerization, suspension polymerization, or dispersion polymerization, a copolymer of a methacrylic acid ester or an acrylic acid ester, condensation-polymerization type resins such as silicone, benzoguanamine, and nylon, and thermosetting resins.

Further, these external additives may be treated with a surface treating agent to increase hydrophobicity, thereby making it possible to prevent degradation in a high humidity condition. Examples of the surface treating agent include silane-coupling agents, silylation agents, silane-coupling agents containing a fluoroalkyl group, organic titanate-based coupling agents, aluminum-based coupling agents, silicone oil, and modified silicone oils.

Examples of a cleaning characteristic improving agent added to the toner to remove a developer remaining on a photosensitive body as a latent image carrier or a transfer belt as a primary transfer medium (body) after transfer include metal salts of a fatty acid, such as zinc stearate, calcium stearate, and stearic acid, and polymer fine particles manufactured by soap-free emulsification polymerization, such as polymethyl methacrylate fine particles and polystyrene fine particles. Preferably, the polymer fine particles have a relatively narrow particle size distribution and a volume average particle size of 0.01 μm to 1 μm.

A developing method using toner formed of the various materials described above allows usage of any electrostatic latent image carrier used according to the conventional electrophotography process. For example, an organic electrostatic latent image carrier, a non-crystalline-silica electrostatic latent image carrier, a selenium electrostatic latent image carrier, a zinc oxide electrostatic latent image carrier, etc., may be suitably used.

According to an aspect of the present invention, a surface treating apparatus, an image forming apparatus, and an image forming system are provided that ensure good fusing quality even in the case of forming a toner image on a transfer material using oil-less toner containing a release agent.

According to an aspect of the present invention, surface treatment is performed by causing dielectric barrier discharge on or near the surface of a transfer material without a toner image formed on the surface so that the surface of the transfer material is directly exposed to the dielectric barrier discharge. This surface treatment using dielectric barrier discharge makes it possible to dramatically increase the amount of energy provided to the surface of the transfer material compared with the conventional case of using corona discharge. Further, due to the direct exposure to dielectric barrier discharge, the energy is provided to the surface of the transfer material with higher efficiency. Further, this dielectric barrier discharge makes it possible to generate a wider variety of active species in a region in contact with the surface of the transfer material compared with the conventionally-employed corona discharge. As a result, even in the case of forming a toner image on the transfer material using oil-less toner containing a release agent, it is possible to ensure an increase in the wettability of the surface of the transfer material with respect to the oil-less toner forming the toner image. Accordingly, even in the case of forming a toner image on the transfer material using oil-less toner containing a release agent, it is possible to obtain sufficient adhesion for fusing the toner image onto the transfer material, so that it is possible to ensure good fusing quality.

According to an aspect of the present invention, an image forming apparatus includes a toner image forming part configured to form a toner image on a surface of a transfer material; a fusing part configured to fuse the toner image using a fusing member; and a surface treating unit configured to treat the surface of the transfer material to be conveyed to the toner image forming part, the surface treating unit including a discharge part configured to cause a dielectric barrier discharge on or near the surface of the transfer material where the toner image is to be formed and to cause the surface of the transfer material to be directly exposed to the dielectric barrier discharge, so as to increase a wettability of the surface of the transfer material with respect to a toner for forming the toner image.

According to an aspect of the present invention, an image forming system includes an image forming apparatus including a toner image forming part configured to form a toner image on a surface of a transfer material; and a fusing part configured to fuse the toner image using a fusing member; and a transfer material treating apparatus configured to treat the surface of the transfer material to be conveyed to the toner image forming part, the transfer material treating apparatus including a transfer material input part to which the transfer material is input; a surface treating unit configured to treat the surface of the transfer material fed from the transfer material input part on which surface the toner image is to be formed, the surface treating unit including a discharge part configured to cause a dielectric barrier discharge on or near the surface of the transfer material where the toner image is to be formed and to cause the surface of the transfer material to be directly exposed to the dielectric barrier discharge, so as to increase a wettability of the surface of the transfer material with respect to a toner for forming the toner image; and a transfer material output part configured to output the transfer material that has the surface thereof treated in the surface treating unit.

The present invention is not limited to the specifically disclosed embodiments, and variations and modifications may be made without departing from the scope of the present invention.

The present application is based on Japanese Priority Application No. 2010-271885, filed on Dec. 6, 2010, the entire contents of which are incorporated herein by reference.

What is claimed is:

1. A surface treating apparatus configured to treat a surface of a transfer material, comprising:
a discharge part configured to cause a dielectric barrier discharge on or near the surface of the transfer material where a toner image is to be formed and to cause the surface of the transfer material to be directly exposed to the dielectric barrier discharge, so as to increase a wettability of the surface of the transfer material with respect to a toner for forming the toner image.

2. The surface treating apparatus as claimed in claim 1, further comprising:
a transfer material feed part configured to feed the transfer material;
a transfer material conveyance part configured to convey the transfer material fed from the transfer material feed part so that the surface of the transfer material passes through a discharge region where the dielectric barrier discharge is caused by the discharge part; and
a transfer material output part to which the transfer material that has passed through the discharge region is output.

3. The surface treating apparatus as claimed in claim 2, wherein the transfer material output part includes a placement base on which the output transfer material is stacked.

4. The surface treating apparatus as claimed in claim 2, wherein the transfer material feed part and the transfer material output are configured to move in a direction perpendicular to the surface of the conveyed transfer material.

5. The surface treating apparatus as claimed in claim 1, wherein the discharge part includes:
a first electrode member so provided as to face the surface of the transfer material and extend in a direction to cross a direction in which the transfer material is conveyed;
a second electrode member including an electrically conductive member and a dielectric layer formed on a surface of the electrically conductive member, the second electrode member being so provided as to face the first electrode member across the transfer material; and
a voltage applying part configured to apply a voltage between the first electrode member and the electrically conductive member of the second electrode member.

6. The surface treating apparatus as claimed in claim 5, wherein the voltage applied by the voltage applying part is an alternating-current voltage having a peak-to-peak voltage value of more than or equal to 5 kVp-p and less than or equal to 30 kVp-p.

7. The surface treating apparatus as claimed in claim 5, wherein
each of the first electrode member and the second electrode member has a roller shape, and
the second electrode member is larger in diameter than the first electrode member.

8. The surface treating apparatus as claimed in claim 7, further comprising:
a drive part configured to rotate the second electrode member,
wherein the second electrode member has the dielectric layer defining an entire outer peripheral surface of the second electrode member in a circumferential direction.

9. The surface treating apparatus as claimed in claim 8, wherein
the dielectric layer of the second electrode member has a relative permittivity of more than or equal to 2 and less than or equal to 10, and
the dielectric layer of the second electrode member has a thickness of more than or equal to 0.1 mm and less than or equal to 5 mm.

10. The surface treating apparatus as claimed in claim 9, wherein the voltage applied by the voltage applying part is an alternating-current voltage having a frequency of higher than or equal to 20 kHz and lower than or equal to 500 kHz.

11. The surface treating apparatus as claimed in claim 1, further comprising:
a transfer material conveyance part configured to convey the transfer material so that the surface of the transfer material passes through a discharge region where the dielectric barrier discharge is caused by the discharge part, the transfer material conveyance part including a conveyor belt wound around a plurality of support rollers to convey the transfer material, and
the discharge part includes
a first electrode member so provided as to face the surface of the transfer material conveyed by the conveyor belt and extend in a direction to cross a direction in which the transfer material is conveyed;
a second electrode member so provided as to face the first electrode member across a part of the conveyor belt on which part the transfer material is conveyed; and
a voltage applying part configured to apply a voltage between the first electrode member and the second electrode member.

12. An image forming apparatus, comprising:
a toner image forming part configured to form a toner image on a surface of a transfer material;
a fusing part configured to fuse the toner image using a fusing member; and
a surface treating unit configured to treat the surface of the transfer material to be conveyed to the toner image forming part,
the surface treating unit including
a discharge part configured to cause a discharge on or near the surface of the transfer material where the toner image is to be formed thereon.

13. The image forming apparatus as claimed in claim 12, wherein the toner image forming part is configured to form the toner image using an oil-less toner containing a release agent.

14. An image forming system, comprising:
an image forming apparatus including
a toner image forming part configured to form a toner image on a surface of a transfer material using an oil-less toner containing a release agent; and
a fusing part configured to fuse the toner image using a fusing member; and
a transfer material treating apparatus configured to treat the surface of the transfer material to be conveyed to the toner image forming part,
the transfer material treating apparatus including
a transfer material input part to which the transfer material is input;
a surface treating unit configured to treat the surface of the transfer material fed from the transfer material input part on which surface the toner image is to be formed, the surface treating unit including a discharge part configured to cause a discharge on or near the surface of the transfer material where the toner image is to be formed; and
a transfer material output part configured to output the transfer material that has the surface thereof treated in the surface treating unit.

15. The image forming system as claimed in claim 14, wherein the toner image forming part of the image forming apparatus is configured to form the toner image using an oil-less toner containing a release agent.
